(19) United States
(12) Patent Application Publication
(10) Pub. No.: US 2009/0129685 A1
(43) Pub. Date: May 21, 2009

(54) IMAGE PROCESSING APPARATUS, IMAGE TRANSMITTING APPARATUS AND METHOD AND PROGRAM OF THE SAME AND DISPLAY DEVICE

(75) Inventor: Daigo Miyasaka, Tokyo (JP)

Correspondence Address: YOUNG & THOMPSON, 209 Madison Street, Suite 500, ALEXANDRIA, VA, 22314, US

(73) Assignee: NEC Corporation, Tokyo (JP)

(21) Appl. No.: 12/095,883

(22) PCT Filed: Nov. 20, 2006
(86) PCT No.: PCT/JP2006/323108

§ 371 Date: Jun. 2, 2008

(30) Foreign Application Priority Data
Dec. 1, 2005 (JP) 2005-347917

(51) Int. Cl. G06K 9/36; H04N 1/40

(52) U.S. Cl. 382/232; 358/471

(57) ABSTRACT

In an image processing/transmitting apparatus and method, graininess is suppressed while remarkably the appearance in the image area with a smooth gradation and the flat image area, the number of bit planes is reduced and then increased. The second image processing module includes a bit adding module executing bit adding based on the two-dimensional dither matrix for compressed data read from memory and obtaining decompressed data, an LPF processing threshold value generator obtaining a threshold value from decompressed data, and an LPF processing module attaining a difference between decompressed data of a pixel and decompressed data of a peripheral pixel, which sets a result of weighted mean processing for decompressed data of the pertinent and peripheral pixels to the output image data if the difference is within the threshold, and which sets the decompressed data of an arbitrary pixel to the output image data if the difference value>threshold.

### TECHNICAL FIELD

The present invention relates to an image processing and transmitting apparatus and a method and a program of the same and a display device, and in particular, to an image processing apparatus, a transmitting apparatus, a display device, an image processing method, and an image transmitting method.

### RELATED ART

Today, as a method to transmit an image from a computer to a display, there has been employed a method to transmit a raster image for each frame frequency. In this method, image data not compressed is transmitted, and it is not attempted to reduce the amount of transmission data.

Also, accumulation of raster images in a one-screen memory is carried out not only on the computer side but also on the display side. Image data is in an uncompressed state also when the display side accumulates the raster images in the memory, and it is not attempted to reduce the memory capacity required to accumulate the raster images of one screen.

Since the amount of data of raster images increases as the fineness and the degree of gradation of images become higher, it is required to increase the transmission capacity of the transmission path as well as the capacity of the memory for the accumulation; however, if the data amount of raster images becomes greater, it is technically more difficult to increase the data transmission capacity and the memory capacity, and this soars the costs.

As one method of coping with the higher fineness and the higher gradation degree without increasing the data transmission capacity and the memory capacity, there can be considered a method of transmitting an image by compressing the image in a file format such as JPEG and GIF.

However, to conduct compression and decompression processing for each frame, there is required an arithmetic processing device capable of conducting high-speed operation, which leads to increase in the costs. Additionally, since picture quality greatly varies depending on a feature of the image, it is difficult to obtain almost equal picture quality for any kinds of images.

Moreover, as another image compression method, there exists a block encoding method employed also in JPEG. In the block encoding method, image data is divided into square blocks each including a predetermined number of pixels to compress the image data by use of a correlation between intra-block pixels.

However, for an image compressed in the block encoding method, the decompression processing is generally conducted also for each block. Therefore, the block encoding method is attended with a problem of random accessibility to the image data. That is, since it is required to carry out a change and a readout of image data for each block, a change and a readout of image compressed data cannot be conducted for only a part of the block. This is a problem particularly when the method is applied to a frame memory of a display device.

In addition, when the method is applied to a display device, image data of a block extending in a sub-scan direction is required to be processed as a unit, it is necessary to use a line memory to keep the pixel data. This is because data of the raster image is linear data; if a block extends in the sub-scan direction, it is required, after image data of a line is inputted, to keep the image data until at least image data of a subsequent line is inputted.

As above, in the respective methods, there exist a problem of a large variation in picture quality depending on the feature of an image and a problem of the random accessibility to the image.

As another processing method to cope with the higher fineness and the higher gradation degree without increasing the amount transmission data and the memory capacity, it can be considered to reduce the number of bit planes of the raster image. The number of bit planes in this situation indicates, in a digital image quantized in a gradation degree of (n-th power of two), the number of bits n of data representing the gradation. As a method of reducing the number of bit planes, there exists methods such as a multi-value dither method and a fixed threshold value method, and details of the methods are disclosed in Non-patent Document 1.

The multi-value dither method and the fixed threshold value method are different from the image compression methods such as the JPEG format, the GIF format, and the block encoding method, and it is not required to expand a compressed image.

However, in the multi-value dither method and the fixed threshold value method of the prior art, there exist occurrence of a false contour and a false color and graininess appearance as a result of the reduction in the number of bit planes, which leads to a problem of deterioration in picture quality.

As a prior art to solve these problems, there exists “image processing apparatus, image transmission apparatus, image receiving apparatus, and image processing method” disclosed in Patent Document 1. FIG. 1 shows structure of an image processing apparatus disclosed in Patent Document 1. In this processing apparatus, dither processing is executed for input image according to X and Y coordinates of the image and then the image is quantized to be stored in a memory. Data read from the memory is dequantized and then reverse processing of the dither processing is executed for the input image, and the resultant data is fed to a display device.

In the processing of Patent Document 1, picture quality is not easily changed for any image. Also, even if the objective image of the processing is relatively small, the size of the circuit required to be added to execute the processing of Patent Document 1 is smaller than the memory circuit size which can be reduced by compressing the image, and hence this is applicable as a method of reducing the frame memory capacity of a cellular phone.

Additionally, as another conventional technique to solve the problem, there exists “image data processing apparatus” disclosed in Patent Document 2. In the configuration of the processing apparatus disclosed in Patent Document 2, there are disposed an image data compression circuit to compress image data using a dither method, an image memory to store the compressed image data, and an image data decompression circuit. The decompression circuit compares reference image data in the compressed image data from the image memory with peripheral pixel data thereof such that depending on a result of the comparison, the decompression circuit determines to output the reference pixel data itself or an integration value associated with the reference pixel data and peripheral pixel data selected from the peripheral pixel data. As a result, the image data can be compressed by suppressing deterioration in picture quality to a relatively low magnitude of deterioration and the compressed data can be appropriately reproduced.

Patent Document 1: Japanese Patent Laid-Open Pub. Ser. No. 2003-162272
Patent Document 2: Japanese Patent Laid-Open Pub. Ser. No. Hei-7-298259

### Non-patent Document 1; New Version “Image Electronics Handbook” p. 41-51

### DISCLOSURE OF THE INVENTION

### Problem to be Solved by the Invention

However, also in the inventions disclosed in Patent Documents 1 and 2, there is graininess appearance, although quite slightly, in the image after the reproduction. The graininess appearance is particularly conspicuous in an image with a smooth gradation (an image including areas in which the gradation degree or level gradually changes) and in a flat image (an image including areas represented with an equal gradation value).

It is an object of the present invention, which has been devised in consideration of the problems, to provide an image processing and transmitting apparatus and a method and a program of the same and a display device suitable for executing processing in which while remarkably suppressing the graininess appearance in the image area with a smooth gradation and the flat image area, the number of bit planes is reduced and is thereafter increased.

### Means for Solving the Problems

To achieve the object, there is provided as a first mode in accordance with the present invention an image processing apparatus first image processing means for compressing input image data to reduce a data amount of the data and generating compressed data, a memory for storing the compressed data of the image, and second image processing means for decompressing the compressed data read from the memory and producing output image data, characterized in that the first image processing means includes a compression threshold value generator module for generating a two-dimensional dither matrix on the basis of x and y coordinates of the input image data and bit plane compressing means for executing multi-value dither processing for the input image data by use of a compression threshold value based on the two-dimensional dither matrix to reduce the number of bit planes for the input image data and obtaining the compressed data and the second image processing means includes a bit plane decompressing module for executing bit adding processing based on the two-dimensional dither matrix for the compressed data read from the memory and obtaining decompressed data, a smoothing threshold value generator module for obtaining a threshold value from the decompressed data of an arbitrary pixel, and a smoothing processing module which attains a difference between the decompressed data of an arbitrary pixel and the decompressed data of a peripheral pixel thereof, which sets a result of weighted mean processing for the decompressed data of an arbitrary pixel and the decompressed data of the peripheral pixel to the output image data if the difference value is within the threshold value, and which sets the decompressed data of an arbitrary pixel to the output image data if the difference value is more than the threshold value.

In the first mode of the present invention, it is favorable that the compression threshold value generator module generates the two-dimensional dither matrix on the basis of a data value of the input image data as well as the x and y coordinates of the input image data.

In either configuration of the first mode of the present invention, it is favorable that the smoothing processing module produces the output image data on the basis of the decompressed data of a plurality of peripheral pixels of the arbitrary pixel. Also, it is desirable that the bit plane decompressing module sets a value of the decompressed data to a value corresponding to a maximum gradation value if a value of the compressed image data is an available maximum value and sets the value of the decompressed data to a value corresponding to a minimum gradation value if the value of the compressed image data is an available minimum value. Furthermore, it is desirable that the bit plane decompressing module executes the bit adding processing on the basis of the two-dimensional dither matrix by use of a decompression threshold value different from the compression threshold value. In addition, it is favorable that the smoothing processing module sets, if both of a value of the decompressed data of the arbitrary pixel and a value of the decompressed data of the peripheral pixel are equal to or less than a first predetermined value, the result of the weighted mean processing as the output data regardless of the value of the differential value. Moreover, it is favorable that the smoothing processing module sets, if both of a value of the decompressed data of the arbitrary pixel and a value of the decompressed data of the peripheral pixel are equal to or more than a second predetermined value, the result of the weighted mean processing as the output data regardless of the value of the differential value. Additionally, it is desirable that the smoothing threshold value generator module obtains a threshold value on the basis of the decompressed data of the arbitrary pixel and the compressed data of the pixel.

Also, to achieve the object, there is provided as a second mode in accordance with the present invention an image transmitting apparatus including a first apparatus including first image processing means for compressing input image data to reduce a data amount of the data and generating compressed data and means for transmitting the compressed data and a second apparatus including means for receiving the compressed data transmitted from the first apparatus and second image processing means for decompressing the compressed data and producing output image data, characterized in that the first image processing means includes a compression threshold value generator module for generating a two-dimensional dither matrix on the basis of x and y coordinates of the input image data and bit plane compressing means for executing multi-value dither processing for the input image data by use of a compression threshold value based on the two-dimensional dither matrix to reduce the number of bit planes for the input image data and obtaining the compressed data and the second image processing means includes a bit plane decompressing module for executing bit adding processing based on the two-dimensional dither matrix for the compressed data received as above and obtaining decompressed data, a smoothing threshold value generator module for obtaining a threshold value from the decompressed data of an arbitrary pixel, and a smoothing processing module which attains a difference between the decompressed data of an arbitrary pixel and the decompressed data of a peripheral pixel thereof, which sets a result of weighted mean processing for the decompressed data of an arbitrary pixel and the decompressed data of the peripheral pixel to the output image data if the difference value is within the threshold value, and which sets the decompressed data of an arbitrary pixel to the output image data if the difference value is more than the threshold value.

In the second mode of the present invention, it is desirable that the compression threshold value generator module generates the two-dimensional dither matrix on the basis of a data value of the input image data as well as the x and y coordinates of the input image data.

In either configuration of the second mode of the present invention, it is desirable that the smoothing processing module produces the output image data on the basis of the decompressed data of a plurality of peripheral pixels of the arbitrary pixel. Also, it is favorable that the bit plane decompressing module sets a value of the decompressed data to a value corresponding to a maximum gradation value if a value of the compressed image data is an available maximum value and sets the value of the decompressed data to a value corresponding to a minimum gradation value if the value of the compressed image data is an available minimum value. Additionally, it is desirable that the bit plane decompressing module executes the bit adding processing on the basis of the two-dimensional dither matrix by use of a decompression threshold value different from the compression threshold value. Also, it is desirable that the smoothing processing module sets, if both of a value of the decompressed data of the arbitrary pixel and a value of the decompressed data of the peripheral pixel are equal to or less than a first predetermined value, the result of the weighted mean processing as the output data regardless of the value of the differential value. Furthermore, it is favorable that the smoothing processing module sets, if both of a value of the decompressed data of the arbitrary pixel and a value of the decompressed data of the peripheral pixel are equal to or more than a second predetermined value, the result of the weighted mean processing as the output data regardless of the value of the differential value. Also, it is desirable that the smoothing threshold value generator module obtains a threshold value on the basis of the decompressed data of the arbitrary pixel and the compressed data of the pixel.

Moreover, in order to achieve the object, there is provided as a third mode in accordance with the present invention an image display device including first image processing means for compressing input image data to reduce a data amount of the data and generating compressed data, a memory for storing the compressed data, second image processing means for decompressing the compressed data read from the memory and producing output image data, and image display means for displaying an image of the output image data, characterized in that the first image processing means includes a compression threshold value generator module for generating a two-dimensional dither matrix on the basis of x and y coordinates of the input image data and bit plane compressing means for executing multi-value dither processing for the input image data by use of a compression threshold value based on the two-dimensional dither matrix to reduce the number of bit planes for the input image data and obtaining the compressed data and the second image processing means includes a bit plane decompressing module for executing bit adding processing based on the two-dimensional dither matrix for the compressed data read from the memory and obtaining decompressed data, a smoothing threshold value generator module for obtaining a threshold value from the decompressed data of an arbitrary pixel, and a smoothing processing module which attains a difference between the decompressed data of an arbitrary pixel and the decompressed data of a peripheral pixel thereof, which sets a result of weighted mean processing for the decompressed data of an arbitrary pixel and the decompressed data of the peripheral pixel to the output image data if the difference value is within the threshold value, and which sets the decompressed data of an arbitrary pixel to the output image data if the difference value is more than the threshold value.

In the third mode of the present invention, it is favorable that the compression threshold value generator module generates the two-dimensional dither matrix on the basis of a data value of the input image data as well as the x and y coordinates of the input image data.

In either configuration of the mode of the present invention, it is desirable that the soothing processing module produces the output image data on the basis of the decompressed data of a plurality of peripheral pixels of the arbitrary pixel. Furthermore, it is desirable that the bit plane decompressing module sets a value of the decompressed data to a value corresponding to a maximum gradation value if a value of the compressed image data is an available maximum value and sets the value of the decompressed data to a value corresponding to a minimum gradation value if the value of the compressed image data is an available minimum value. Furthermore, it is favorable that the bit plane decompressing module executes the bit adding processing on the basis of the two-dimensional dither matrix by use of a decompression threshold value different from the compression threshold value. Additionally, it is desirable that the smoothing processing module sets, if both of a value of the decompressed data of the arbitrary pixel and a value of the decompressed data of the peripheral pixel are equal to or less than a first predetermined value, the result of the weighted mean processing as the output data regardless of the value of the differential value. Also, it is favorable that the smoothing processing module sets, if both of a value of the decompressed data of the arbitrary pixel and a value of the decompressed data of the peripheral pixel are equal to or more than a second predetermined value, the result of the weighted mean processing as the output data regardless of the value of the differential value. In addition, it is desirable that the smoothing threshold value generator module obtains a threshold value on the basis of the decompressed data of the arbitrary pixel and the compressed data of the pixel.

Furthermore, to achieve the object, there is provided as a fourth mode in accordance with the present invention an image processing method including a first image processing step of compressing input image data to reduce a data amount of the data and generating compressed data, a step of storing the compressed data in a memory, and a second image processing step of decompressing the compressed data read from the memory and producing output image data, characterized in that the first image processing step executes compression threshold value generating processing for generating a two-dimensional dither matrix on the basis of x and y coordinates of the input image data and bit plane compressing processing of executing multi-value dither processing for the input image data by use of a compression threshold value based on the two-dimensional dither matrix to reduce the number of bit planes for the input image data and obtaining the compressed data and the second image processing step executes bit plane decompressing processing of executing bit adding processing based on the two-dimensional dither matrix for the compressed data read from the memory and obtaining decompressed data, smoothing threshold value generating processing for obtaining a threshold value from the decompressed data of an arbitrary pixel, and smoothing processing which attains a difference between the decompressed data of an arbitrary pixel and the decompressed data of a peripheral pixel thereof, which sets a result of weighted mean processing for the decompressed data of an arbitrary pixel and the decompressed data of the peripheral pixel to the output image data if the difference value is within the threshold value, and which sets the decompressed data of an arbitrary pixel to the output image data if the difference value is more than the threshold value.

In the fourth mode of the present invention, it is favorable that the compression threshold value generating processing generates the two-dimensional dither matrix on the basis of a data value of the input image data as well as the x and y coordinates of the input image data.

In either configuration of the fourth mode of the present invention, it is desirable the smoothing processing produces the output image data on the basis of the decompressed data of a plurality of peripheral pixels of the arbitrary pixel. Additionally, it is desirable that the bit plane decompressing processing sets a value of the decompressed data to a value corresponding to a maximum gradation value if a value of the compressed image data is an available maximum value and sets the value of the decompressed data to a value corresponding to a minimum gradation value if the value of the compressed image data is an available minimum value. Furthermore, it is favorable that the bit plane decompressing processing executes the bit adding processing on the basis of the two-dimensional dither matrix by use of a decompression threshold value different from the compression threshold value. Also, it is desirable that the smoothing processing sets, if both of a value of the decompressed data of the arbitrary pixel and a value of the decompressed data of the peripheral pixel are equal to or less than a first predetermined value, the result of the weighted mean processing as the output data regardless of the value of the differential value. In addition, it is desirable that the smoothing processing sets, if both of a value of the decompressed data of the arbitrary pixel and a value of the decompressed data of the peripheral pixel are equal to or more than a second predetermined value, the result of the weighted mean processing as the output data regardless of the value of the differential value. Moreover, it is favorable that the smoothing threshold value generating processing obtains a threshold value on the basis of the decompressed data of the arbitrary pixel and the compressed data of the pixel.

Moreover, in order to achieve the object, there is provided as a fifth mode in accordance with the present invention an image transmitting method including a first image processing step of compressing input image data to reduce a data amount of the data and generating compressed data, a step of transmitting the compressed data, and a second image processing step of decompressing the compressed data and producing output image data, characterized in that the first image processing step executes compression threshold value generating processing of generating a two-dimensional dither matrix on the basis of x and y coordinates of the input image data and bit plane compressing processing of executing multi-value dither processing for the input image data by use of a compression threshold value based on the two-dimensional dither matrix to reduce the number of bit planes for the input image data and obtaining the compressed data and the second image processing step executes bit plane decompressing processing of executing bit adding processing based on the two-dimensional dither matrix for the compressed data transmitted as above and obtaining decompressed data, smoothing threshold value generating processing of obtaining a threshold value from the decompressed data of an arbitrary pixel, and smoothing processing which attains a difference between the decompressed data of an arbitrary pixel and the decompressed data of a peripheral pixel thereof, which sets a result of weighted mean processing for the decompressed data of an arbitrary pixel and the decompressed data of the peripheral pixel to the output image data if the difference value is within the threshold value, and which sets the decompressed data of an arbitrary pixel to the output image data if the difference value is more than the threshold value.

In the fifth mode of the present invention, it is desirable that the compression threshold value generating processing generates the two-dimensional dither matrix on the basis of a data value of the input image data as well as the x and y coordinates of the input image data.

In either configuration of the fifth mode of the present invention, it is favorable that the smoothing processing produces the output image data on the basis of the decompressed data of a plurality of peripheral pixels of the arbitrary pixel. Additionally, it is desirable that the bit plane decompressing processing sets a value of the decompressed data to a value corresponding to a maximum gradation value if a value of the compressed image data is an available maximum value and sets the value of the decompressed data to a value corresponding to a minimum gradation value if the value of the compressed image data is an available minimum value. Also, it is favorable that the bit plane decompressing processing executes the bit adding processing on the basis of the two-dimensional dither matrix by use of a decompression threshold value different from the compression threshold value. In addition, it is desirable that the smoothing processing sets, if both of a value of the decompressed data of the arbitrary pixel and a value of the decompressed data of the peripheral pixel are equal to or less than a first predetermined value, the result of the weighted mean processing as the output data regardless of the value of the differential value. Moreover, it is desirable that the smoothing processing sets, if both of a value of the decompressed data of the arbitrary pixel and a value of the decompressed data of the peripheral pixel are equal to or more than a second predetermined value, the result of the weighted mean processing as the output data regardless of the value of the differential value. Additionally, it is favorable that the smoothing threshold value generating processing obtains a threshold value on the basis of the decompressed data of the arbitrary pixel and the compressed data of the pixel.

Moreover, in order to achieve the object, there is provided as a sixth mode in accordance with the present invention an image processing program characterized by making a computer execute either one image processing method of the fourth mode of the present invention.

Also, in order to achieve the object, there is provided as a seventh mode in accordance with the present invention an image processing program characterized by making a computer execute either one image processing method of the fifth mode of the present invention.

### OPERATION

In accordance with the present invention, the compression and the decompression of a bit map image can be carried out using a smaller number of logic items, and it is possible to reduce the transmission capacity required to transmit a raster image to a display device or the like and to reduce the memory capacity to store the raster image.

Also, in accordance with the present invention, since an image for which a bit addition has been conducted is smaller in the error with respect to an original image when compared with the conventional image processing method, the graininess appearance occurring when the error is large can be suppressed and there is implemented high-quality display.

Additionally, since the block encoding is not used in the image compression and decompression, the random accessibility to image data is kept retained, and it is possible to realize a configuration in which partial readout and partial write of an image can be easily carried out.

### EFFECTS OF THE INVENTION

In accordance with the present invention, there can be provided an image processing and transmitting apparatus and a method and a program of the same and a display device suitable for executing processing in which while remarkably suppressing the graininess appearance in the image area with a smooth gradation and the flat image area, the number of bit planes is reduced and is thereafter increased.

### BEST MODE FOR CARRYING OUT THE INVENTION

### Principle of the Invention

The graininess appearance occurring in the image processing (bit plane compression and decompression) according to the prior art is caused by an error occurring before and after the image processing (the difference in the gradation value before and after the processing), and the error becomes greater for a higher spatial frequency component. Such error of the higher spatial frequency component is conspicuous in areas of a smooth gradation image and a flat image; on the other hand, the error is not conspicuous in areas with an abrupt gradation change such as an edge section and a fine line.

To suppress the error of the higher spatial frequency component, Patent Document 1 discloses a method to reduce the error (amplitude) and Patent Document 2 discloses a method to make the error not conspicuous by use of a spatial Low-Pass Filter (LPF).

The method of suppressing the error varies between the error reduction of Patent Document 1 and the operation of Patent Document 2 to make the error not conspicuous, and it is hence possible to further reduce the error by combining these methods with each other.

In a situation wherein these processings are combined with each other, there is favorably employed a sequence of processings in which the processing to reduce magnitude of the error is first executed and then the LPF processing is carried out. This is because the processing to reduce magnitude of the error is reverse processing of the dither processing, and this processing does not contribute to the reduction in the error unless data employed at compression is used. The LPF processing on the other hand is processing only to reduce the error of the higher spatial frequency component, and hence the quantity of error can be reduced regardless of the amplitude of the error (namely, irrespective of the processing sequence).

However, only by combining the two processings solely in the above sequence, there occurs the following problem in the reduction of the error.

The problem here is that in the LPF processing to be executed after the reverse processing of the dither processing, it is not possible to obtain a good result in determining whether or not the LPF processing is to be executed according to a comparison result obtained by simply comparing adjacent pixels with each other as in the prior art.

In the prior art, the error (namely, the high-frequency component to be reduced by conducting the LPF processing) occurring through the dither processing is fixed (i.e., with the difference of one gradation) throughout all gradation values. However, when the reverse processing of the dither processing is executed, magnitude of the error component varies depending on the gradation value. Therefore, to reduce the error component throughout the gradation values, it is favorable to determine whether or not the LPF processing is to be executed according to a variable threshold value attained from a value of image data.

Favorableness of determining whether or not the LPF processing is to be executed according to a variable threshold value attained from a value of image data will be described by use of a specific example.

Assume an example of processing in which a 6-bit input image is compressed into a 4-bit image and the 4-bit image is again restored to a six-bit image. In this situation, the dither processing disclosed in Patent Document 1 is represented by the following expression.

(compressed data)=((input image data:in)−(compression threshold value:Tenc(x,y)))/4

where, the compression threshold value Tenc is expressed as in FIG. 2 by using X and Y coordinate values x,y of the input image data in. Here, “X mod Y” represents a remainder obtained by dividing X by Y.

Also, the decompression processing as a reverse processing of the dither processing is represented by the following expression.

(decompressed data)=(compressed data)×4+(compression threshold value: Tdec(x,y))

where, the decompression threshold value Tdec is expressed as an input and output table of FIG. 3 by using X and Y coordinate values xm,ym of the compressed data. However, the decompression threshold value is always “0” if the compressed data is “0” and the decompression threshold value is always “3” if the compressed data is “15”. Generally speaking, in a situation wherein an A-bit input image is compressed into a B-bit image and the B-bit image is then restored to an A-bit image, the decompression threshold value is always “0” if the compressed data is “0” and the decompression threshold value is always “2̂(A−B)−1” if the compressed data is “2̂B−1”.

All expressions described above are shown in FIG. 4. FIG. 4 shows compressed data and decompressed data for each set including an input gradation and compression threshold value−decompression threshold value. Also, FIG. 4 shows a difference between an output mean value and an input gradation value for each input gradation.

The compression threshold value takes one of −2, −1, 0, 1, and 2, and the decompression threshold value takes one of 0, 1, 2, and 3. If the compression threshold value is −2, the decompression threshold value is 0. If the compression threshold value is −1, the decompression threshold value may take 0 or 1. If the compression threshold value is 0, the decompression threshold value may take 1 or 2. If the compression threshold value is 1, the decompression threshold value may take 2 or 3. If the compression threshold value is 2, the decompression threshold value is 3.

In FIG. 4, each value in a column of a compression threshold value corresponds to each value in a column of a decompression threshold value, and the decompression data is determined by the respective values. For example, if the compression threshold value is “−1” and the decompression threshold value is “1”, the value of the compressed data is identified as a third value from the left corresponding to the decompression threshold value=“1” in the second and third values from the left in the decompressed data column corresponding to the compression threshold value=“−1”. Specifically, in a situation wherein the input gradation is “8”, the compression threshold value is “−1”, and the decompression threshold value is “1”, the decompressed data is the third value relative to the left in the decompressed data, i.e., nine.

For both of the compression and decompression threshold values, each of the values thereof is used twice in 4×4 pixels and the threshold value is repeated with a 4×4 pixel period, and hence when a flat picture (an image for which all pixels take an equal gradation value) is inputted, if the output mean value is equal to the input gradation value, brightness does not change in the overall image before and after the compression and the decompression. Here, a difference between the output mean value and the input gradation value is defined as “overall error”. The overall error is desirably smaller, which can lead to higher gradation reproducing performance. In addition, a difference between an input and each decompressed data is defined as “individual error”. It is favorable in the present invention that the threshold value is variable because the distribution of individual errors considerably varies according to the input gradation. Incidentally, a problem regarding the overall error will be described later.

Also, as can be seen by referring to the part of the compressed data in FIG. 4, the threshold value of Patent Document 2 as the prior art is obtained from deviation of the individual error caused by the dither processing and the value is fixed (one-gradation difference) throughout all input gradation values. For example, if a flat picture of four gradation values is inputted in FIG. 4, the compressed data output (this corresponds to Patent Document 2) is only “0” or “1”, and the difference therebetween is one gradation and hence the threshold value is also of ±one gradation (if other compressed data output value is viewed using a particular compressed data output value as a reference, the difference therebetween is one gradation or less). On the other hand, the data (decompressed data) after the compression and decompression processing of Patent Document 1 includes four items of 0, 4, 5, and 6; the maximum value of the difference between outputs is “6”, and the threshold value is also of ±six gradations.

Moreover, by adding a case wherein a seven-gradation flat picture is inputted, the difference between outputs is as shown in Table 1.

TABLE 1

| Input | Compressed data | Decompressed data |
|---|---|---|
| 4 | 0, 1 | 0, 4, 5, 6 |
| 7 | 1, 2 | 5, 6, 7, 8, 9 |

For the compressed data when the flat pictures of two kinds are inputted, the difference between outputs is of ±one gradation in both pictures; however, for the decompression data, the difference between outputs differs from each other and is of ±6 and ±4.

In addition, by confirming the difference for all gradations, the maximum of the difference between decompressed data is four gradations when the input ranges from six gradations to 57 gradations; the difference considerably varies from zero gradation to seven gradations when the input is equal to or less than five gradations or equal to or more than 58 gradations. This implies that the threshold value to determine whether or not the LPF processing is executed for the decompressed data is to be changed according to the value of the decompressed data to be outputted as the image data. If the threshold value is determined in association with the maximum value of the all gradations, the LPF processing is executed more strongly than required, which hence does not lead to an increase in picture quality. This point conspicuously varies from Patent Document 2 of the prior art.

On the other hand, if whether or not the LPF processing is executed is determined by use of the compressed data without using the decompressed data, it seems to be considerable that the operation to vary the threshold as in the above configuration can be dispensed with. However, also in this situation, the LPF processing is executed more strongly than required, which hence does not lead to an increase in picture quality. That is, even if whether or not the LPF processing is executed is determined on the basis of the compressed data, the error is not reduced.

Hence, when the two methods are implemented in combination, it is required to change the threshold value according to the value of the decompressed data; the picture quality cannot be increased only by simply combining the two methods with each other.

According to the present invention, the two methods are used in combination and whether or not the LPF processing is executed is determined according to the value of the decompressed data. This makes it possible to suppress double the deviation in the individual error.

In summary, the elements required to implement the operation of the present invention are as follows.

There is provided an image processing method including first image processing means for compressing the data capacity of input image data, a memory for storing compressed data of an image whose data amount has been reduced by the first image processing means, and second image processing means for decompressing compressed data read from the memory and for producing outputting image data, wherein the first image processing means includes a compression threshold value generator module for generating a two-dimensional dither matrix on the basis of x and y coordinates of the input image data and bit plane compressing means for executing multi-value dither processing by use of the compression threshold value to reduce the number of bit planes of the input image data, and the second image processing means includes bit plane decompressing module for executing bit adding processing for the compressed data based on the two-dimensional dither matrix to obtain decompressed data and smoothing processing means which obtains threshold value data from pertinent image data of decompressed data, which calculates a difference between the pertinent image data and peripheral pixel data, which sets a weighted mean processing result as output image data if the difference value is within a range of the threshold value, and which sets the pertinent image data as output image data if the difference value is beyond the range.

By applying the above elements to an image processing apparatus, an image processing method, and an image processing program, it is possible, while keeping the random access characteristic and while remarkably suppressing the graininess appearance in a smooth gradation area and a flat image area to keep picture quality, to reduce the data capacity to thereby reduce the memory capacity and the transmission capacity.

First, in an image processing apparatus, image data is compressed in the above method before the data is stored in the memory and compressed data read from the memory is decompressed; hence, a high-quality image can be reproduced even the memory capacity is reduced. In this situation, for each of the image compression processing and the image decompression processing, an apparatus, a program, and another method can be selected to execute the processing. For example, the image compression processing can be executed by an image compression apparatus and the image decompression processing can be carried out by an image decompression program.

Also, the image compression processing can be executed by an image compression program and the image decompression processing can be conducted by an image decompression apparatus. As above, derivative modes of the image processing apparatus include an image processing method, an image processing program, an image compression apparatus for which only image compression processing is extracted, an image compression method, an image compression program, an image decompression apparatus for which only image decompression processing is extracted, an image decompression method, and an image decompression program.

Next, in the image transmitting apparatus, before image data is transmitted via a transmission path, the data is compressed to be transmitted in the above method; the data transmitted via the transmission path is decompressed, which makes it possible to reproduce a high-quality image even through a restricted transmission path. In this situation, for each of the image transmitting processing and the image receiving processing, an apparatus, a program, and another method can be selected to execute the processing. For example, the image transmitting processing can be executed by an image transmitting apparatus and the image receiving processing can be carried out by an image receiving program. Also, the image transmitting processing can be executed by an image transmitting program and the image receiving processing can be carried out by an image receiving apparatus. As above, derivative modes of the image transmitting apparatus include an image transmitting method, an image transmitting program, an image transmitting apparatus for which only image transmitting processing is extracted, an image transmitting method, an image transmitting program, an image receiving apparatus for which only image receiving processing is extracted, an image receiving method, and an image receiving program.

Additionally, in a display device, when image data is compressed in the above method before the data is stored in a memory and compressed data outputted from the memory is decompressed to display an image, a high-quality image can be displayed even when the memory capacity is reduced.

Next, description will be given of an exemplary embodiment suitable for the present invention based on the principle described below.

### FIRST EXEMPLARY EMBODIMENT

Description will be given of a first exemplary embodiment favorably implementing the present invention. FIG. 5 shows a configuration of an image processing apparatus according to the exemplary embodiment. This image processing apparatus is an apparatus to execute image processing on the basis of the principle described above and is configured such that a first image processing module 4 compresses a raster image 1 including 6-bit R, G, and B colors transmitted from a computer into a raster image including four bits for each color, the compressed raster image is stored in a memory 2, a second image processing module 5 converts the accumulated raster image including four bits for each color into an image including six bits for each color, and the image is fed to an image display module 3 capable of displaying the 6-bit image.

In this connection, although FIG. 5 shows a block configuration for one of the colors R, G, and B, the apparatus includes similar configurations for the other two colors in a parallel fashion.

The first image processing module 4 includes a compression threshold value generator module 205, a quantizing module 208, and an adder 22. The compression threshold value generator module 205 receives as an input thereto X and Y coordinates (x,y) of a pixel of the raster image 1 and generates based thereon a threshold value to be used in dither processing. The quantizing module 208 removes two low-order bits from 6-bit data inputted thereto and outputs therefrom only four high-order bits.

The compression threshold value generator module 205 generates, based on the inputted X and Y coordinates (x,y) of the pixel, an output signal (to be also referred to as an initial threshold value hereinbelow). In FIG. 2, [x,mod4] indicates the remainder obtained by dividing the X coordinate value (x) of the pixel by four and [y,mod4] indicates the remainder obtained by dividing the Y coordinate value (y) of the pixel by four. The compression threshold value generator module 205 generates an output from these results [x,mod4] and [y,mod4].

The output from the compression threshold value generator module 205 is sent to the adder 22 and is subtracted from the 6-bit raster image. The adder 22 feeds its operation result to the quantizing module 208. Thereafter, the module 208 converts data inputted from the adder 22 into 4-bit data and accumulates data of a raster image including a reduced number of bit planes in the memory 2.

The raster image including a reduced number of bit planes and being stored in the memory 2 is converted by the second image processing module 5 into an image including six bits for each color and is sent to the image display module 3.

The second image processing module 5 includes a bit adding module 207, a decompression threshold value generator module 206, an LPF processing module 210, and an LPF processing threshold value generator module 209.

The decompression threshold value generator module 206 generates, like the compression threshold value generator module 205, an output signal (decompression threshold value) based on x and y coordinates (x,y) of an inputted pixel. FIG. 3 shows its output table. Although the output table may be the same as that of the compression threshold value generator module 205 (in other words, the compression threshold value may be equal to the decompression threshold value), different tables are employed in consideration of the offset.

FIG. 6 shows an internal configuration of the bit adding module 207.

If the signal inputted from the memory 2 is “1111” (maximum value), the bit adding module 207 outputs “1111111” (maximum value) regardless of the value inputted from the decompression threshold value generator module 206. Additionally, if the signal inputted from the memory 2 is “0000” (minimum value), the bit adding module 207 outputs “000000” (minimum value) regardless of the value inputted from the decompression threshold value generator module 206. In a situation wherein the signal inputted from the memory 2 to the bit adding module 207 is neither “1111” nor “0000”, the bit adding module 207 adds a threshold value (two bits) inputted from the decompression threshold value generator module 206 to a lower position of the 4-bit signal inputted from the memory 2 and then outputs the signal to the LPF processing module 210 and the LPF processing threshold value generator module 209.

FIG. 7 shows structure of the LPF processing module 210 and the LPF processing threshold value generator module 209. The LPF processing module 210 accumulates in a register D1 one pixel of decompressed data from the bit adding module 207, uses data delayed by the accumulation as peripheral pixel data, and uses the input signal, i.e., the decompressed data as pertinent pixel data. The pertinent pixel data and the peripheral pixel data are added to each other by an adder and the 1-bit quantizer Q rounds one lower-most bit to obtain mean data as a mean value of the pertinent pixel data and the peripheral pixel data. Thereafter, on the basis of an output signal sel from the LPF processing threshold value generator module 209, a selection is made to output the mean data as output data or to output the pertinent pixel data.

In the LPF processing threshold value generator module 209, there are similarly obtained pertinent pixel data A and peripheral pixel data B by use of a register D2. Thereafter, if either one of three judge conditions described below is satisfied, “0” is outputted as the output signal sel; if neither one thereof is satisfied, “1” is outputted as the output signal sel.

A=7 and B=7 (1)

A=56 and B=56 (2)

abs(A−B)<4 (3)

where, abs(X) is an absolute value of X. Conditions (1) and (2) are based on threshold values near the minimum gradation values and the maximum gradation values for which the appearing error is large, and condition (3) is based on threshold values at the other intermediate gradations (the maximum value of the difference between outputs for intermediate gradations (for example, if the input gradation is 30 in the exemplary embodiment, the minimum value and the maximum value of the decompressed data are 28 and 32, and hence the threshold value is “4”)). As above, by use of not only the comparison between the pertinent pixel data and the peripheral pixel data, but also the values themselves of the pertinent pixel data and the peripheral pixel data, a selection is made to output the mean data or the decompressed data. Therefore, the threshold value can be set according to the gradation value of the decompressed data (in other words, the selection can be made to output the mean data or the decompressed data).

In this regard, the setting of conditions (1) and (2) are not restricted by the above example. That is, any expression to set each condition of the same range in FIG. 4 is applicable. For example, it is possible to designate “pertinent pixel data A is 7 or less and B−4<A<B+8 is satisfied” for condition (1) above, and “pertinent pixel data A is 56 or more and B−8<A<B+4 is satisfied” for condition (2) above. Condition (3) may be expressed as “B−4<A<B+4 when pertinent pixel data A is 8 or more and 55 or less”, and this expression method indicates that the threshold value is set according to the value of the pertinent pixel data.

Also, it is naturally possible to use a common element for the registers D1 and D2 of the LPF processing module 210 and the LPF processing threshold value generator module 209.

As above, there is obtained the value of the pertinent pixel data of the decompressed data, the difference between the pertinent pixel data and its peripheral pixel data is calculated; if the difference value is within a range of the threshold value, a result of the weighted mean processing for the pertinent pixel data and the peripheral pixel data is employed as output image data; if the difference is beyond the range, the pertinent pixel data is employed as output image data; resultantly, it is for the first time possible to further reduce the high-frequency error in all gradations. Therefore, the graininess appearance is remarkably suppressed in a smooth gradation image area and a flat image area; and it is possible while retaining the picture quality to lower the memory capacity and the transmission capacity by reducing the data capacity.

As above, in the image processing apparatus according to the exemplary embodiment, the chip area and the consumption power can be reduced while minimizing influences upon picture quality.

### SECOND EXEMPLARY EMBODIMENT

Description will be given of a second exemplary embodiment favorably implementing the present invention.

In accordance with the present invention, since the LPF processing is executed in a stage after the compression and decompression processing, a result of higher picture quality with a reduced error is obtained by setting the compression processing for a purpose other than that of the prior art (in other words, by setting it for a purpose to reduce the overall error). Hence, in conjunction with the exemplary embodiment, description will be given of an image processing apparatus which suppresses both of the individual error and the overall error by using a configuration of the compression processing different from the conventional configuration and by disposing the LPF processing in a stage after the compression and decompression processing.

FIG. 8 shows structure of an image processing apparatus according to the exemplary embodiment. The image processing apparatus of the exemplary embodiment is configured in almost the same way as for the image processing apparatus according to the first exemplary embodiment, but the periphery of the compression threshold value generator module differs from that of the first exemplary embodiment.

The errors as a problem in the compression and decompression processing of the raster image include two kinds of errors, i.e., an overall error which is a mean error of the overall gradations before and after the processing and an individual error as the deviation of the error of each pixel. The problem of the prior art is the latter, “individual error”, namely, that the deviation of the individual error is recognized as an error of high-frequency component is regarded as a problem. In this situation, according to Patent Document 1, the compression data and the decompression data are set such that the individual error becomes smaller even if the overall error in the vicinity of the minimum gradation and the maximum gradation becomes slightly larger. In the compression and the decompression processing aiming at the reduction of the individual error, as can be seen from the relationship between the input gradation value and the overall error of FIG. 4, the overall error occurs (the output mean value does not match the input value) in a range from gradation 1 to gradation 5 and a range from gradation 53 to gradation 62 (namely, in the vicinity of the minimum gradation and the maximum gradation). The most problematic situation is associated with the decompressed data of gradation 1 and that of gradation 62. The decompressed data of gradation 1 is entirely equal to that of gradation 0, and the decompressed data of gradation 62 is entirely equal to that of gradation 63. This indicates that through the compression and decompression processing, the individual error exists for neither the decompressed data of gradation 62 nor the decompressed data of gradation 62, but the overall error is large and the gradation indiscrimination occurs.

Suppression of the individual error in the vicinity of the minimum gradation and the maximum gradation can be carried out also through the LPF processing; therefore, in the exemplary embodiment, the operation expression of the compression processing is changed to reduce the overall error in the vicinity of the minimum gradation and the maximum gradation. FIG. 9 shows an input and output table in a situation wherein the compression processing is executed by changing the operation expression to reduce the overall error in the vicinity of the minimum gradation and the maximum gradation. Of the compressed data value and decompressed data value shown in FIG. 9, the values which are changed, as a result of the change of the operation expression for the compression processing, to values different from those of the input and output table shown in FIG. 4 are surrounded by a bold-line frame. Comparing with the input and output table shown in FIG. 4, it is recognized that the overall error is reduced for the gradations including the changed values (values surrounded by the bold-line frame). There respectively occurs differences between compressed data of gradation 0 and compressed data of gradation 1 and between compressed data of gradation 62 and compressed data of gradation 63, and the gradation indiscrimination has been removed.

However, in this situation, if a flat picture with gradation values near the minimum gradation or the maximum gradation is inputted, the deviation of the individual error is too large, and the graininess appearance is perceivable and picture quality is deteriorated. To cope therewith, the deviation of the individual error is suppressed by the LPF processing.

FIG. 10 shows output values when a flat picture of gradation value “1” is inputted. (a) indicates a situation using a conversion table aiming at reduction of the individual error, (b) indicates a situation in which the operation expression is varied to reduce the overall error near the minimum gradation and the maximum gradation, and (c) indicates a situation wherein the operation expression is changed to reduce the overall error near the minimum gradation and the maximum gradation and the LPF processing is further executed for the decompression result (decompressed data). The output values indicate values of a total of 32 pixels for X=0 to 7 and Y=0 to 3.

In FIG. 10(a), it is recognized that although the deviation of the individual error is absent, the overall error is large and there are obtained the same outputs as for the flat picture of gradation 0 and the gradation indiscrimination occurs. Also, since the deviation of the individual error is absent from the decompressed data, the decompressed data values are kept unchanged through any LPF processing, and hence the gradation indiscrimination cannot be solved.

On the other hand, in FIG. 10(b), although the overall error is small, the deviation of the individual error is large as four gradations, and hence the graininess appearance possibly occurs.

As shown in FIG. 10(c), by further conducting the LPF processing, the individual error is reduced to half, and the suppression of the overall error and that of the individual error can be simultaneously achieved.

As can be seen from FIGS. 10 (a) and (b), it is difficult in the conventional method to simultaneously realize the suppression of the overall error and that of the individual error.

Incidentally, in the LPF processing of FIG. 10(c), although there is used a mean value associated with adjacent pixels, the individual error can be smaller if the range of the adjacent pixels is greater. The range of the adjacent pixels may be designated according to necessity.

As above, by combining the change of the operation expression to reduce the overall error in the vicinity of the minimum gradation and the maximum gradation with the LPF processing, there is attained a new advantage of the suppression of the overall error, in addition to the suppression of the individual error which is the advantage of the inventions disclosed by Patent Documents 1 and 2. Moreover, to change the input and output relationship shown in FIG. 4 to that shown in FIG. 9 (to reduce the overall error in the vicinity of the minimum gradation and the maximum gradation), it is only required to alter the operation expression representing the relationship between the input and output values as follows.

(compressed data)=((input image data:in)−(compression threshold value:Tenc(x,y,in)))/4

That is, the compression threshold value is to be determined not only based on the X and Y coordinates of the input image data as in the image processing apparatus according to the first exemplary embodiment but also based on the input image data in.

In consideration of the point described above, according to the exemplary embodiment, the image data itself (gradation value) of the raster image is also inputted to the compression threshold value generator module 205A together with the X and Y coordinates of pixels of the raster image 1, and the compression threshold value generator module 205A produces the threshold value on the basis of these values.

FIG. 11 shows an input and output table of the compression threshold value generator module 205A. To change the relationship between the input value, the compressed data, and the decompressed data from the values shown in FIG. 4 to those shown in FIG. 9, the compression threshold value generator module 205A obtains the output values from the following conditions (4) to (6) by regarding the output values of the input and output table shown in FIG. 2 as provisional values. Incidentally, the compression threshold value generator module 205A adopts the provisional values and the input values to obtain the output values.

If (input value)−(provisional value)=3, (output value)=(provisional value)−1 (4)

If (input value)−(provisional value)=60, (output value)=(provisional value)+1 (5)

If other than (4) and (5), (output value)=(provisional value) (6)

Through the above processing, part of the values of the compressed and decompressed data can be altered from the values shown in FIG. 4 to those shown in FIG. 8. In this regard, the items changed by using the provisional values are the respective values surrounded by bold lines in FIG. 9.

Incidentally, if the compressed and decompressed data can be similarly altered, conditions (4) to (6) may be represented by conditional expressions other than those described above.

In the image processing apparatus according to the exemplary embodiment, the compression threshold value generator module 205A produces the threshold value based on the data values (gradation values) themselves of the image data of the raster image, the difference between the mean value of the output signals and the input signal is reduced, and the color change and the luminance change also become smaller. This indicates that the gradation shift is suppressed in the image processing apparatus according to the exemplary embodiment.

Furthermore, by arranging the LPF processing module 210 in the second image processing module 5, it is possible as in the image processing apparatus according to the first exemplary embodiment to suppress the increase of the individual error, and the error with a high-frequency characteristic can be suppressed.

As above, in the image processing apparatus according to the present embodiment, the minimization of the overall error and that of the individual error can be simultaneously realized, and there can be attained an output image with higher quality than the image processing apparatus according to the first exemplary embodiment. That is, in the image processing apparatus according to the present embodiment, there can be obtained an image in which the error causing the graininess appearance as well as the average error in the overall screen are simultaneously suppressed. When the image is presented by the display device, there is obtained a display of an image with high picture quality.

### THIRD EXEMPLARY EMBODIMENT

Description will be given of a third exemplary embodiment suitably implementing the present invention. FIG. 12 shows structure of an image processing apparatus according to the exemplary embodiment. Although the image processing apparatus is almost similar to that according to the first exemplary embodiment, the internal configuration of the second image processing module 5 is different.

In the exemplary embodiment, an LPF processing threshold value generator module 209B in the second image processing module receives, as input signals, not only an output from the bit adding module 207, but also an output from the memory 2.

FIG. 13 shows a specific configuration of the LPF processing threshold value generator module 209B and the LPF processing module 210. The LPF processing module 210 is as in the first exemplary embodiment. To the LPF processing threshold value generator module 209B, the compressed data from the memory 2 and the decompressed data from the bit adding module 207 are inputted. For the compressed data and the decompressed data, data items of adjacent one-pixel data items are accumulated by use of the registers D3 and D2; the LPF processing threshold value generator module 209B determines the processing in the LPF processing module 210 (outputs a selection signal) by use of four data items including the outputs from the respective registers, i.e., A (pertinent pixel decompressed data), B (peripheral pixel decompressed data), C (pertinent pixel compressed data), and D (peripheral pixel compressed data). Although the criterion to select the processing is three conditions similar to those of the first exemplary embodiment, conditions (1) and (2) differ from those of the first exemplary embodiment.

A≦7 and B≦7→C≦1 and D≦1 (1)

A≧56 and B≧56→C≧14 and D≧14 (2)

This indicates, as can be seen from FIG. 4, the same data range.

As above, the determination of the threshold value conducted in the LPF processing threshold value generator module 209B can be carried out by using not only the decompressed data, but also the compressed data only if the operation is based on the input gradation. Since the compressed data is smaller in the number of bits than the decompressed data, the circuit size of the LPF processing threshold generator module can be further reduced when the compressed data is used.

The other operations are as in the first exemplary embodiment, and hence duplicated description will be avoided. Incidentally, since the image processing apparatus according to the present embodiment is equivalent to that according to the first exemplary embodiment, the similar advantage is naturally obtained.

In the first to third exemplary embodiments, the first image processing module can be extracted as an image compressing apparatus and the second image processing module can be extracted as an image decompressing apparatus.

### FOURTH EXEMPLARY EMBODIMENT

Description will be given of a fourth embodiment suitably implementing the present invention. FIG. 14 shows structure of an image processing apparatus according to the exemplary embodiment. This apparatus includes a first device 7 to transmit a raster image and a second device 8 to receive a raster image. In the first device 7, a first image processing module 4 converts a raster image of a six-bit gradation for each color into an image of a four-bit gradation for each color (bit-plane compression) and sends the image to the second device 8. In the second device 8, a second image processing module 5A processes the raster image received from the first device 7 to restore the image to a raster image of a six-bit gradation for each color and outputs the image to the image display module 3.

In this connection, the first image processing module 4 is similar to that described in conjunction with the first exemplary embodiment. However, the first image processing module 4 may be similar to those described for the second and third exemplary embodiments.

The second image processing module 5A includes a bit adding module 207, a counter 204, a decompression threshold value generator module 206, an LPF processing module 210, and an LPF processing threshold value generator module 209. The bit adding module 207, the decompression threshold value generator module 206, the LPF processing module 210, and the LPF processing threshold value generator module 209 are as in the first exemplary embodiment. The counter 204 operates in response to pixel data serially delivered from the first device 7 to identify X and Y coordinates of a pixel based on the count value. The counter 204 outputs the X and Y coordinates (x,y) of the pixel to the decompression threshold value generator module 206.

The first device 7 transmits, when transmitting an image, pixel data in a predetermined sequence. Resultantly, the X and Y coordinates of each pixel can be identified on the basis of the count value of the counter 204.

Using such configuration, when transmitting a raster image from the first device 7 to the second device 8, the image can be transmitted using a smaller transmission capacity (bus width) almost without deteriorating the picture quality. This is effective in a situation wherein the original image cannot be transmitted as it is due to an insufficient transmission capacity of the transmission path and in a situation in which it is desired to reduce the number of transmission paths between the first device and the second device.

For example, in a situation wherein it is desired to transmit a raster image of six bits for each color (18 bits in total) between devices of which the transmission path as the transmission medium with only a bus width of 16 bits, the number of bit planes is reduced on the transmission side, the raster image in a state in which the number of bit planes is reduced is transmitted via the transmission path, and the number of bit planes of this image is increased on the reception side; as a result, the respective colors of an image comparable with the original image can be transmitted at the same time.

Although an example of an image transmitting apparatus has been described for the present invention, the image transmitting apparatus may also be constructed in association with various image processing apparatus described for the first to third exemplary embodiments.

Also, the first image processing module of the exemplary embodiment can be extracted as an image transmitting apparatus and the second image processing module thereof can be extracted as an image receiving apparatus.

### FIFTH EXEMPLARY EMBODIMENT

Description will be given of a fifth embodiment suitably implementing the present invention. FIG. 15 shows structure of an image display device according to the exemplary embodiment. The LPF display device is a device in which a first image processing module 4 processes (bit-plane compression) a raster image 1 of six bits for each colors R, G, and B sent from a computer to accumulate a raster image of four bits for each color in a memory 2 and one-line of the image data of four bits for each color is delivered to second image processing modules 6A to 6D to convert the data into six bits for each color; the data is displayed on an image display device 3 capable of displaying 6-bit data.

The second image processing modules 6A to 6D are disposed in association with the respective pixels in the primary scan direction of the image display device 3 and are arranged in an order of 6A, 6B, 6C, 6D, GA, 6B, . . . , and 6D beginning at the origin side. For example, if the display device 3 includes 240 pixels in the X direction, sixty sets each of which including a set of 6A, 6B, . . . , 6D are arranged in parallel.

To each of the modules 6A to 6D, the Y coordinate value “y” of a pixel is delivered.

In second image processing modules 6A, 6B, 6C, and 6D, although the decompression threshold value generator modules 206A, 206B, 206C, and 206D vary from each other in the internal configuration (and hence in the input and output relationship), but are almost similarly configured. Therefore, they will be referred to in a general form as the second image processing module 6X and the decompression threshold value generator modules 206X in the description (“X” in the reference numerals 6X and 206X represents A, B, C, or D).

FIG. 16 shows structure of the second image processing module 6X. The decompression threshold value generator modules 206X creates an output signal on the basis of the inputted Y coordinate value “y” of the pixel. In FIG. 17(a), [Ymod4] indicates a remainder obtained by dividing the pixel Y coordinate values “y” by four. The decompression threshold value generator modules 206X produces an output value based on the result of [Ymod4].

As FIG. 17(b) shows, the output value from the decompression threshold value generator modules 206X corresponds to the each column of the initial threshold value created from the decompression threshold value generator module 206.

The bit adding module 207 is configured as in the first exemplary embodiment. Decompressed data as its output is fed as peripheral pixel data to an LPF processing threshold value generator module 209A, an LPF processing module 210A, and an adjacent second image processing module. Also, to the LPF processing threshold value generator module 209A and the LPF processing module 210A, peripheral pixel data is fed from another adjacent second image processing module 6X. That is, in this configuration, to obtain the peripheral pixel data, there are not used a register as in the LPF processing threshold value generator module 209 and the LPF processing module 210 of the first exemplary embodiment, but the parallel configuration of the second image processing module 6X is employed.

FIG. 18 shows a specific configuration of the LPF processing threshold value generator module 209A and the LPF processing module 210A. The difference thereof from the image processing apparatus according to the first exemplary embodiment is a point of structure in which the adjacent peripheral pixel data is not attained by registers, but by use of the decompressed data from the adjacent second image processing module 6X. The other points are as in the first exemplary embodiment.

In the present embodiment, an output from the LPF processing module 210A is fed as output data to the image display module 3.

The second image processing modules 6X are arranged in parallel for one line of the image display module 3, and hence it is possible to send the one-line pixel data outputted from the memory 2 to the image display module without latching the data.

Resultantly, the circuit to latch the image data is not required, and the circuit size can be reduced.

Incidentally, although the decompression threshold value generator modules 206X are arranged for each of the second image processing modules 6X in the exemplary embodiment, the exemplary embodiment is not restricted by this configuration. For example, there may also be employed a configuration wherein the decompression threshold value generator modules 206A to 206D are disposed outside the second image processing modules 6X such that outputs therefrom are supplied to the processing modules 6X arranged in parallel. By using such configuration, the number of the decompression threshold value generator modules 206X can be reduced, and the circuit size is further reduced.

### SIXTH EXEMPLARY EMBODIMENT

Description will be given of a sixth exemplary embodiment to which the present invention is favorably applied. An image processing method in accordance with the present invention is also executable as software processing using a computer. That is, as FIG. 19 shows, the first image processing module 4 and the second image processing module 5 are configured using software processing by a computer.

FIG. 20 shows a flow of processing in an image processing method according to the present invention. This method is processing in which the number of bit planes of a 6-bit raster image is reduced to that of a 4-bit image to be once stored in the memory 2, and the number of bit planes of an image signal read from the memory 2 is increased to that of a 6-bit image to be displayed on the display device 3. In a sequence of processing, step 3 is processing in the first image processing module 4 and steps 6 and 7 are processings in the second image processing module 5.

FIG. 21 shows in detail processing (processing in step S3) in the first image processing module 4. Also, FIGS. 22 and 23 show in detail processing (processing in steps S6 and S7) in the second image processing module 5.

When an image signal Rin (6 bits) of a raster image 1 is supplied to the image processing apparatus (step S1), information indicating which one pixel corresponds to the input image signal (i.e., X and Y coordinates of the pixel) is extracted (step S2).

Based on the X and Y coordinates of the pixel, the first image processing module 4 determines a signal Rmem (4 bits) to be fed to the memory as follows.

The first image processing module 4 calculates ((xmod4)+1) and ((ymod4)+1) and acquires values of column ((xmod4)+1) and row ((ymod4)+1) from DitherER (the total value matrix shown in FIG. 3; step S31).

If the value of Rin is equal to or more than the value (DitherER−2) obtained by subtracting a constant offset from DitherER (step S32/Yes), the value (quantized value) obtained by dividing by four the value (Rin+2−DitherER) attained by subtracting (DitherER−2) from the value of Rin is set to Rmem (step S33).

If Rin is less than (DitherER−2; step S32/No), Rmem is set to “0” (step S34).

The memory signal Rmem thus attained is stored in the memory 2 (step S4).

When outputting the memory signal Rmem from the memory 2 to the second image processing module 5, information indicating which one pixel corresponds to the memory signal (i.e., X and Y coordinates of the display pixel) is also delivered to the second image processing module 5 together with the signal Rmem (step S5).

The second image processing module 5 acquires a decompressed signal Rdec through bit adding processing (step S6) on the basis of the X and Y coordinates of the display pixel, and then executes selective LPF processing (step S7) to determine an output signal (raster image) Rout (6 bits) to be fed to the display device.

Details of the bit adding processing based on the X and Y coordinates of the display pixel are as follows.

If Rmem=15 (maximum value; step S61/Yes), Rdec is set to 63 (maximum value; step S62′).

If Rmem=0 (minimum value; step S61/No, step S63/Yes), Rdec is set to 0 (minimum value; step S64).

If Rmem≠15 and Rmem≠0 (step S61/No, step S63/No), the system calculates ((xmod4)+1) and ((ymod4)+1), attains a value of column ((xmod4)+1) and row ((ymod4)+1) from DitherDR (the threshold value matrix shown in FIG. 3; step S65), adds the value to a value obtained by multiplying the memory signal Rmem by four, and sets the resultant value to Rdec (step S66).

Details of the selective LPF processing are as follows.

The system extracts pertinent pixel data (the decompressed signal of the pertinent pixel), i.e., Rdec(X) and peripheral pixel data (the decompressed signal of the pixel adjacent to the pertinent pixel), i.e., Rdec(X−1) (step S71). Incidentally, if Rdec(X−1) is absent, Rdec(X+1) may be adopted for Rdec(X−1).

If either one of the following three conditions is satisfied (yes in either one of steps S72, S73, and S74), a mean of Rdec(X) and Rdec(X−1) is set to Rout(X) (step S76).

(Condition A) Rdec(X) and Rdec(X−1) are equal to or less than seven (step S72)
(Condition B) Rdec(X) and Rdec(X−1) are equal to or more than 56 (step S73)
(Condition C) abs(Rdec(X)-Rdec(X−1))<4 is satisfied (step S74)
If none of the three conditions is satisfied (no in each of steps S72, S73, and S74), the value of Rdec(X) is set to Rout(X) (step S75).

The output signal Rout (6 bits) obtained as above is fed to the image display module 3 (step S8).

By replacing the processing of step S3 and processings of steps S6 and S7 with software processing by a computer, it is possible, without employing particular hardware, to conduct image processing as in the image processing apparatus according to the first exemplary embodiment.

Although the flowchart shown in FIG. 20 indicates operation of the image processing as in the image processing apparatus according to the first exemplary embodiment of the present invention, image processing similar to those of the image processing apparatuses according to the second and third exemplary embodiments of the present invention can also be accomplished through software processing by use of a computer.

In this connection, the first and second image processing module 4 and 5 may be configured by software processing on one and the same computer or on mutually different computers. Also, although both processings of the first and second image processing modules 4 and 5 are implemented through software processing by use of a computer in the description of the example, only one of the processings may be carried out by software processing using a computer.

Additionally, in conjunction with the exemplary embodiment, description has been given of a configuration in which the first and second image processing modules of the image processing apparatus are realized through software processing using a computer; however, as for the image transmitting apparatus and the display apparatus, the first and second image processing modules can naturally be configured by software processing using a computer.

Incidentally, although similar configurations are arranged in parallel for the respective colors of R, G, and B in the respective embodiments, the number of reduced bit planes need not be necessarily equal for each color. For example, if the image signal is of a three-color system of R, G, and B, it is favorable that the number of blue bit planes is most reduced, the number of red bit planes is second most reduced, and the number of green bit planes is least reduced. This is because the human eyes are most sensitive to a change in green and is less sensitive to a change in blue.

Additionally, there may be employed a configuration in which the number of bit planes is decreased or increased for only one color or two colors of R, G, and B.

Furthermore, the raster image need not be necessarily a color image including image signals of a plurality of colors, but may be a monochromic image. That is, it is not necessarily required in the configurations of the respective embodiments that the respective colors are arranged in parallel.

In addition, the description of each of the exemplary embodiments has been given in conjunction with a case wherein the number of bit planes are changed as 6→4→6; however, also in other cases, if there is employed processing in which the number of bit planes of an original image is reduced and is then again increased, the number of bit planes is arbitrarily designated before and after the processing. That is, assuming that the number of bit planes of an original image is A, the number of bit planes of data produced from the first image processing module is B, and the number of bit planes of data produced from the second image processing module is C; if a relationship of A>B and B<C is satisfied, the values of A, B, and C are arbitrarily specified.

In this fashion, various modifications are possible in accordance with the present invention.

### BRIEF DESCRIPTION OF DRAWINGS

FIG. 1 is a diagram showing a configuration of an image processing apparatus according to the prior art.

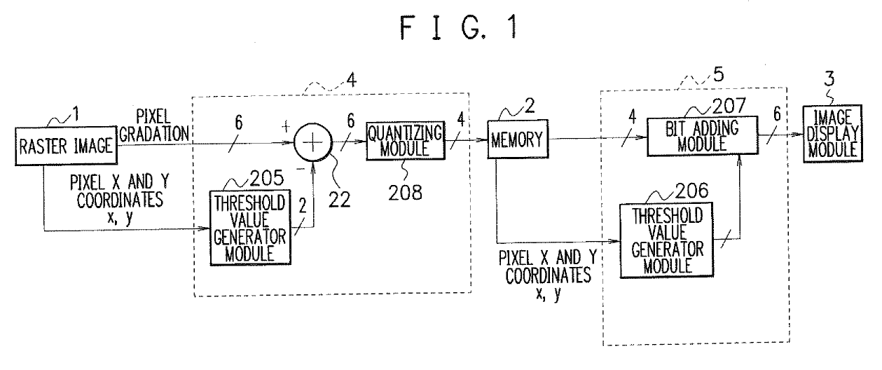

FIG. 2 is a diagram showing a relationship between input values and output values of the compression threshold value generator module.

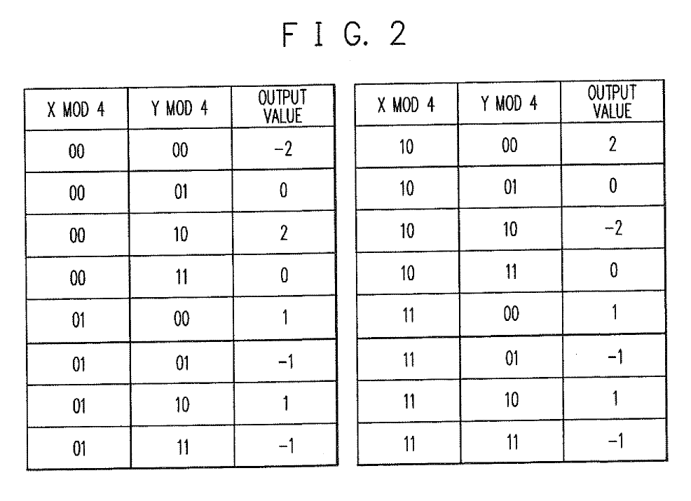

FIG. 3 is a diagram showing a relationship between input values and output values of the decompression threshold value generator module.

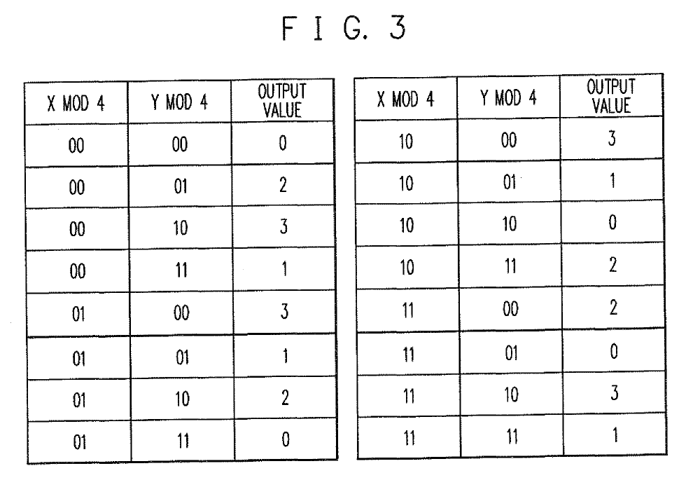

FIG. 4 is a diagram showing a result of compression and decompression processing aiming to reduce the individual error.

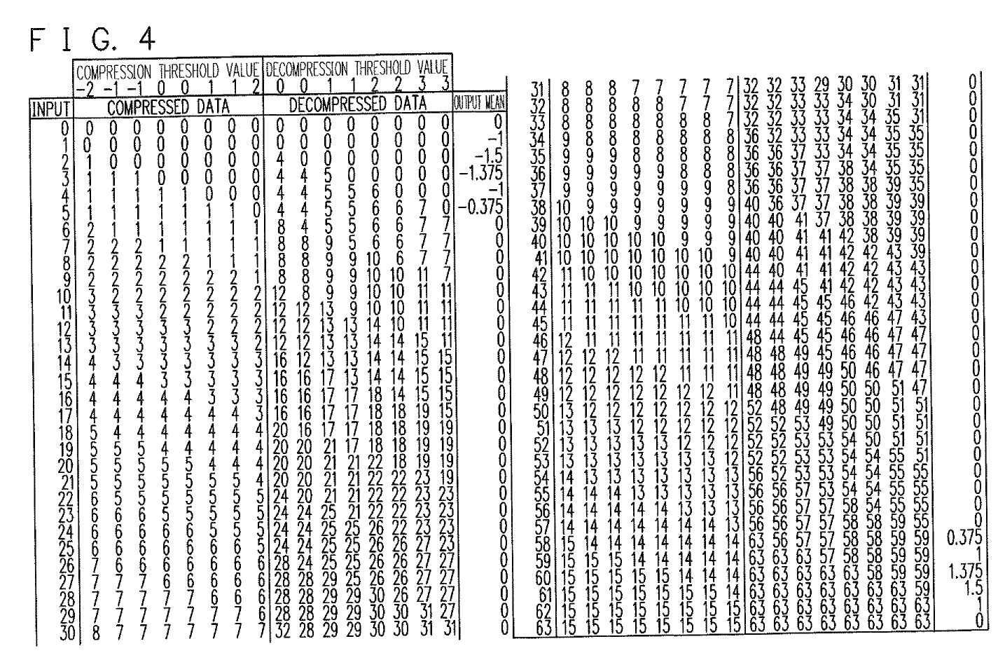

FIG. 5 is a diagram showing structure of an image processing apparatus according to the first exemplary embodiment to which the present invention is suitably applied.

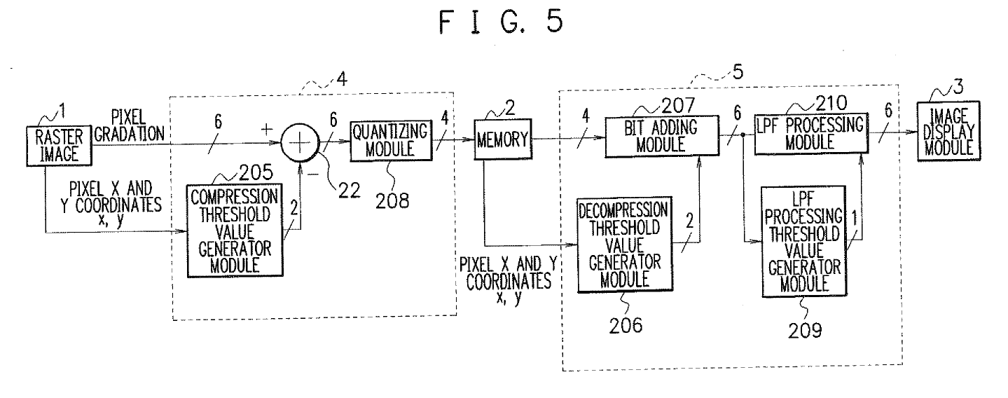

FIG. 6 is a diagram showing a configuration of a bit adding module of the image processing apparatus according to the first exemplary embodiment.

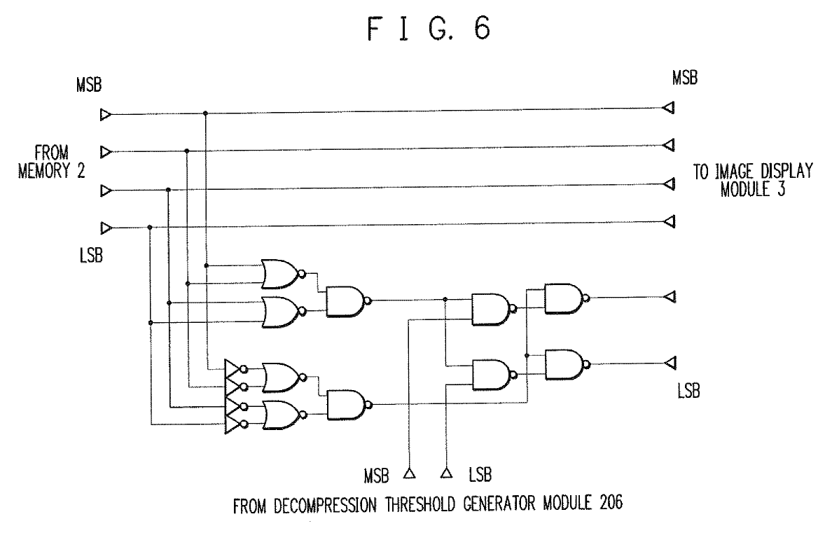

FIG. 7 is a diagram showing structure of an LPF processing module and an LPF processing threshold value generator module according to the first exemplary embodiment.

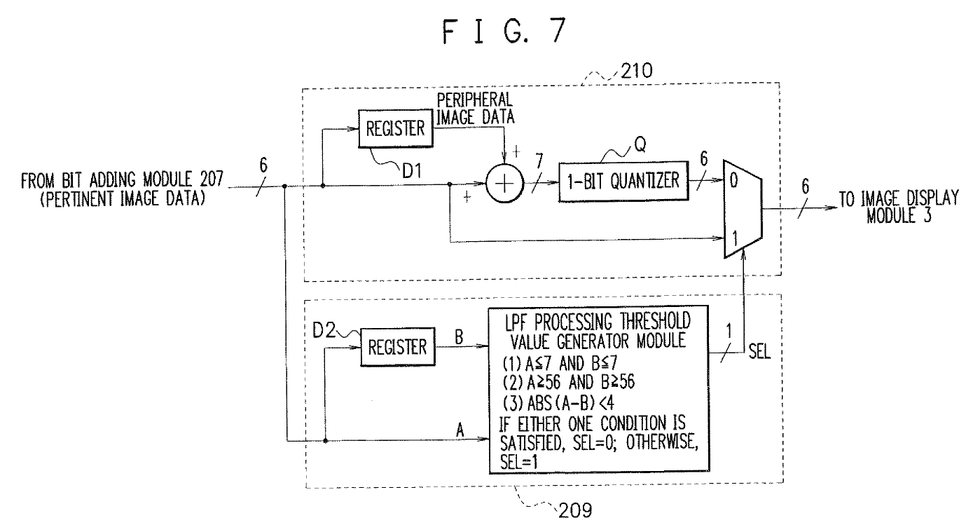

FIG. 8 is a diagram showing structure of an image processing apparatus according to the second exemplary embodiment to which the present invention is suitably applied.

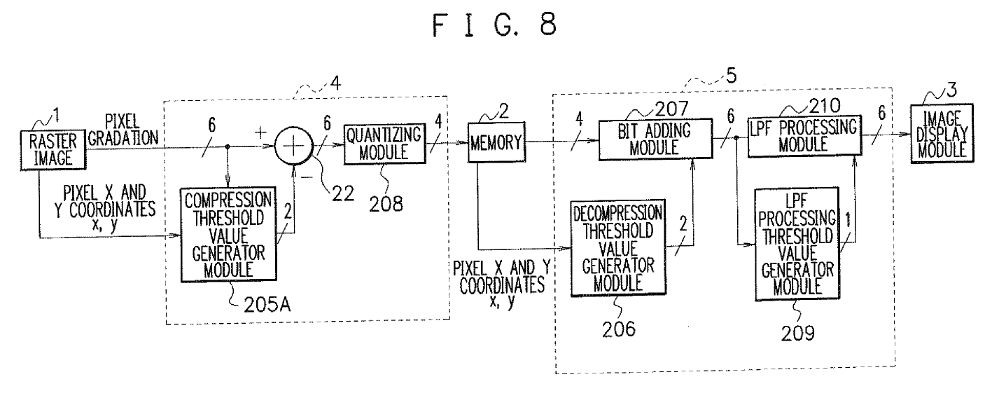

FIG. 9 is a diagram showing a result of compression and decompression processing aiming to reduce the overall error.

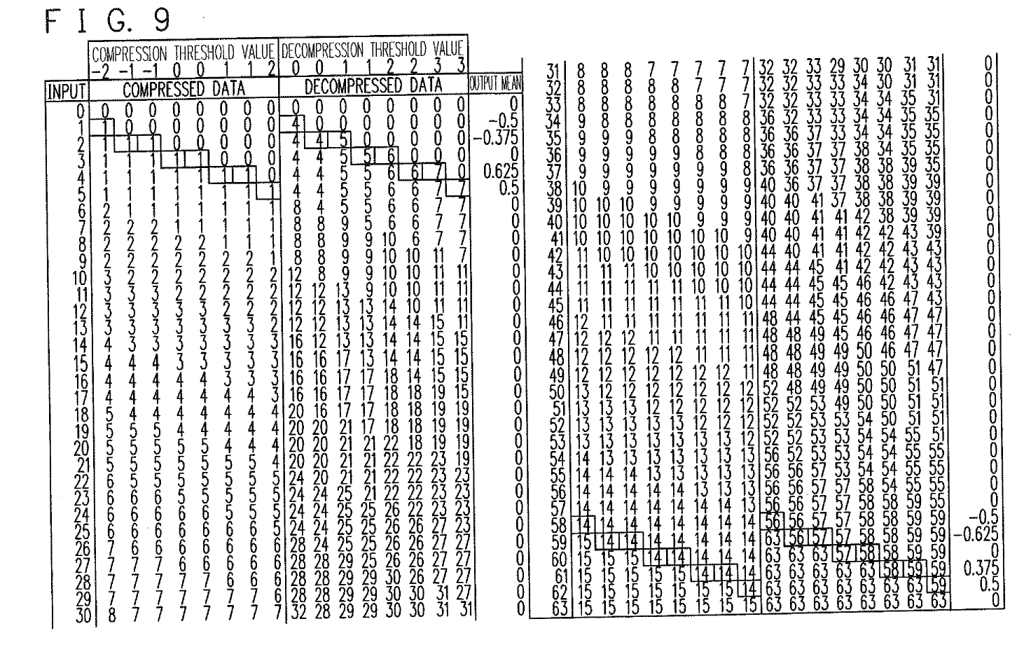

FIG. 10 is a diagram showing a result of processing of a combination of the compression and decompression processing aiming to reduce the overall error with the LPF processing.

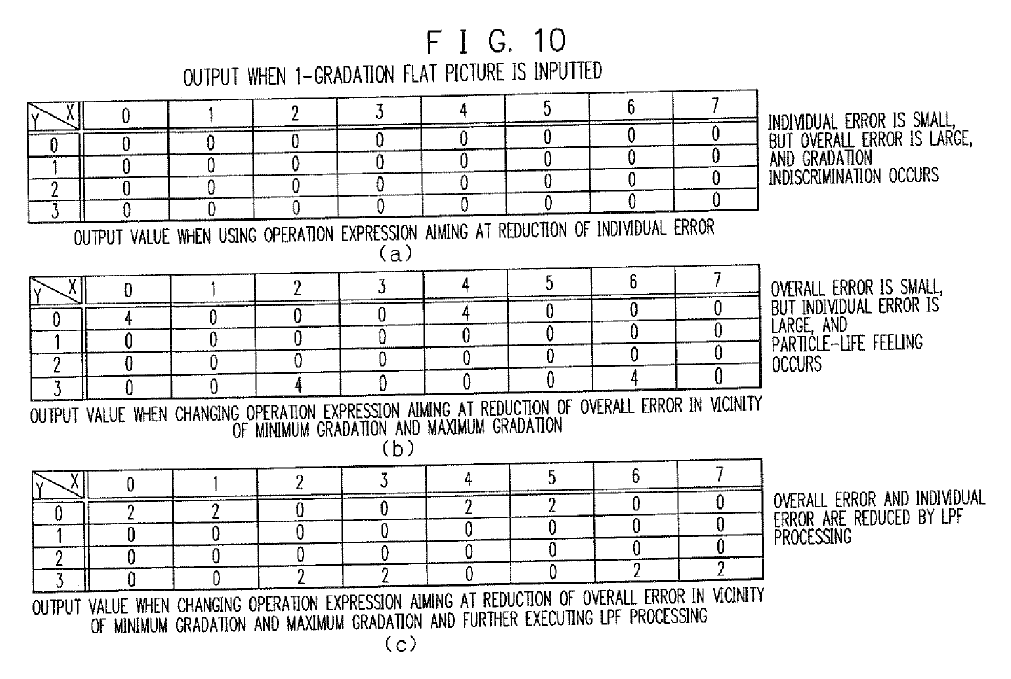

FIG. 11 is a diagram showing a relationship between input values and output values of the compression threshold value generator module of the image processing apparatus according to the second exemplary embodiment.

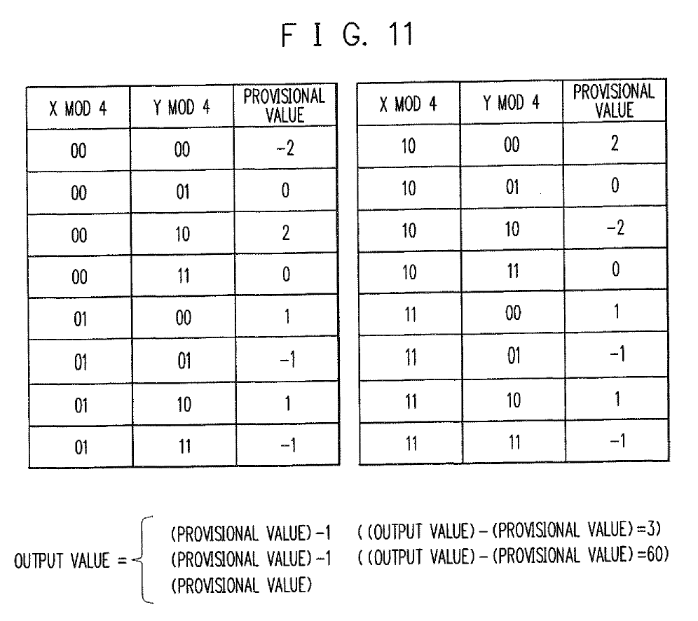

FIG. 12 is a diagram showing structure of an image processing apparatus according to the third exemplary embodiment to which the present invention is suitably applied.

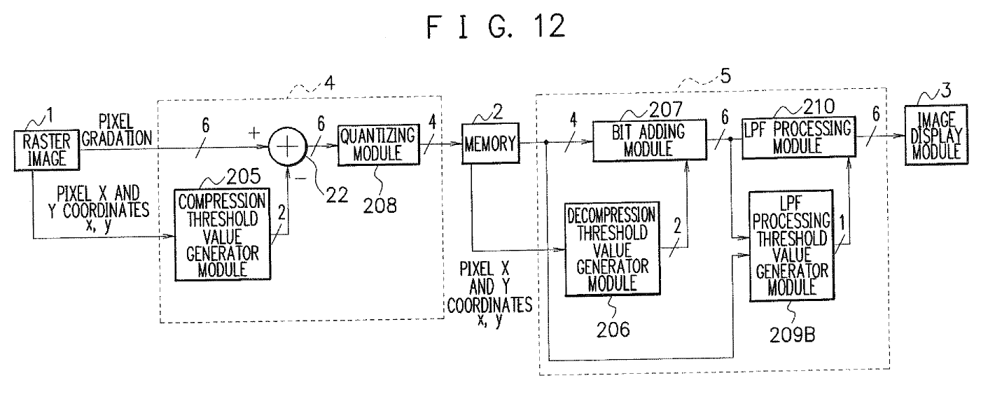

FIG. 13 is a diagram showing structure of an LPF processing module and an LPF processing threshold value generator module of the display device according to the third exemplary embodiment.

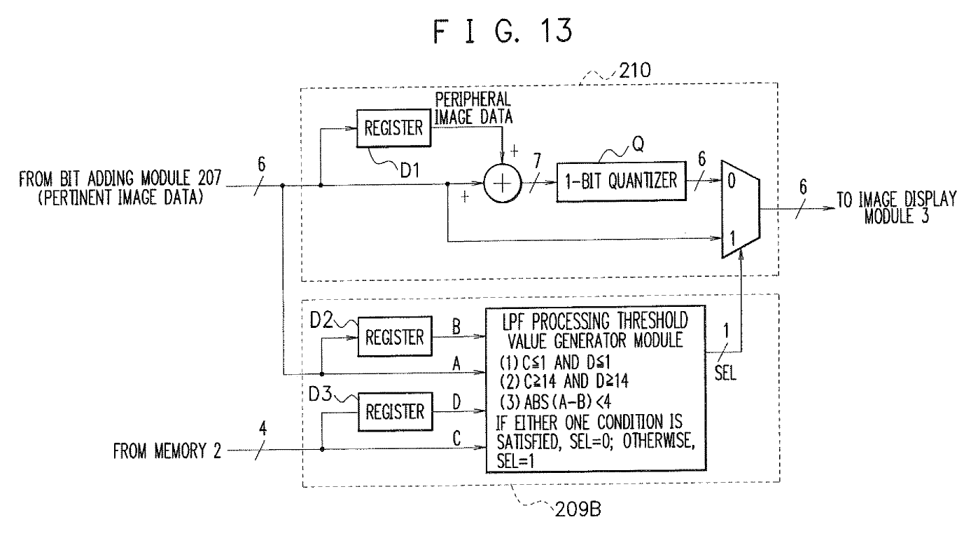

FIG. 14 is a diagram showing structure of an image transmitting apparatus according to the fourth embodiment to which the present invention is suitably applied.

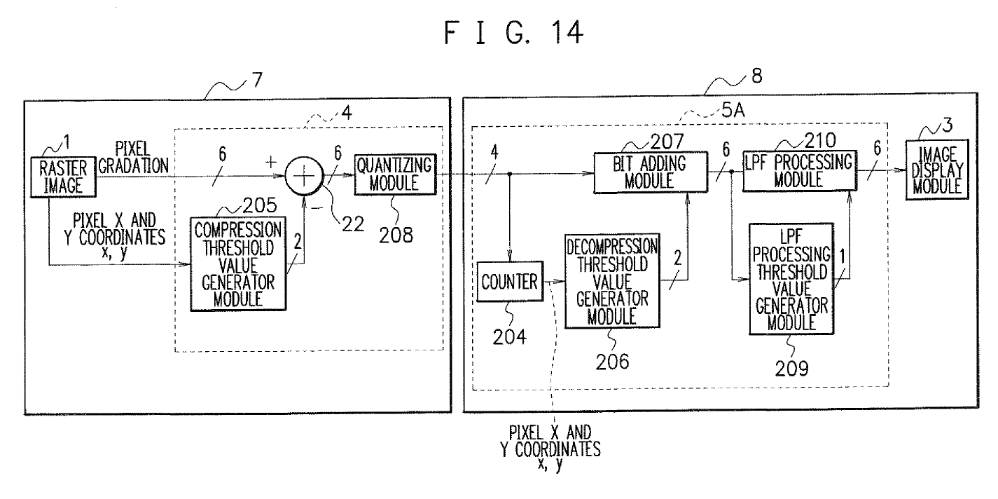

FIG. 15 is a diagram showing structure of a display device according to the fifth exemplary embodiment to which the present invention is suitably applied.

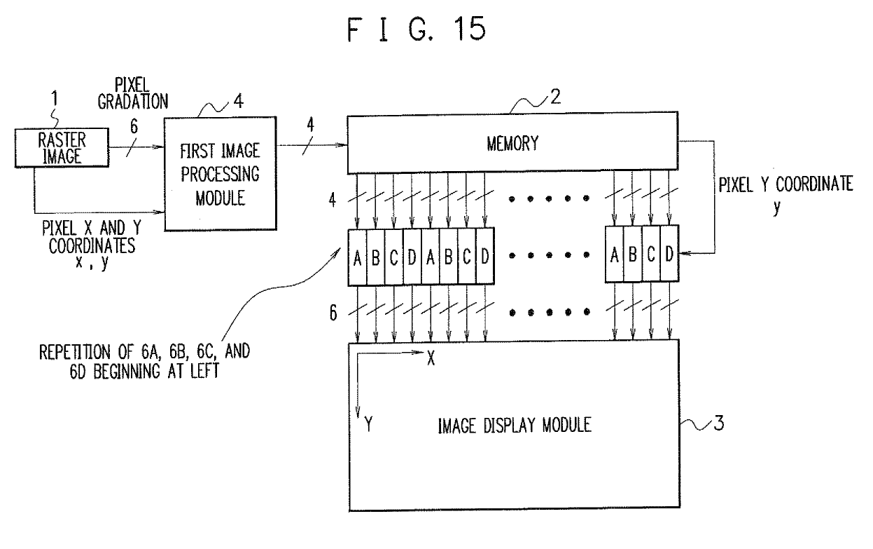

FIG. 16 is a diagram showing a configuration of the display device according to the fifth exemplary embodiment.

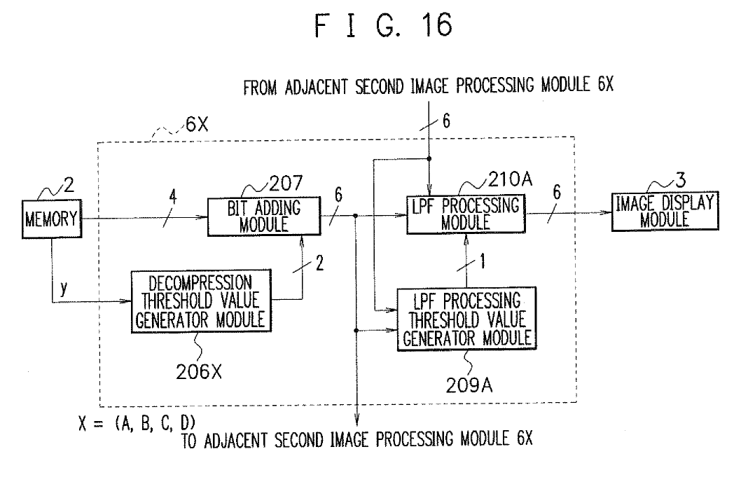

FIG. 17 is a diagram showing a relationship between input values and output values of the decompression threshold value generator module of the display device according to the fifth exemplary embodiment.

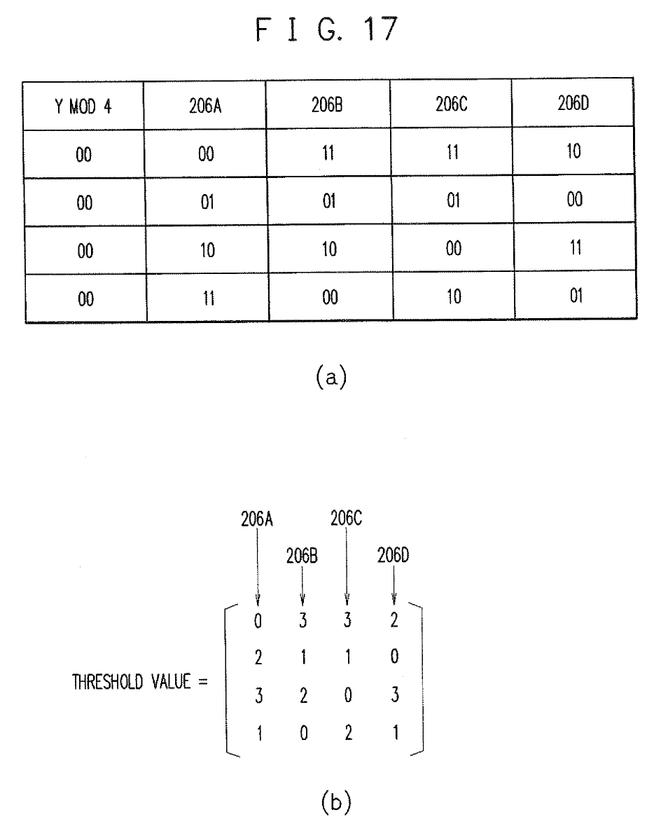

FIG. 18 is a diagram showing structure of an LPF processing module and an LPF processing threshold value generator module of the display device according to the fifth exemplary embodiment.

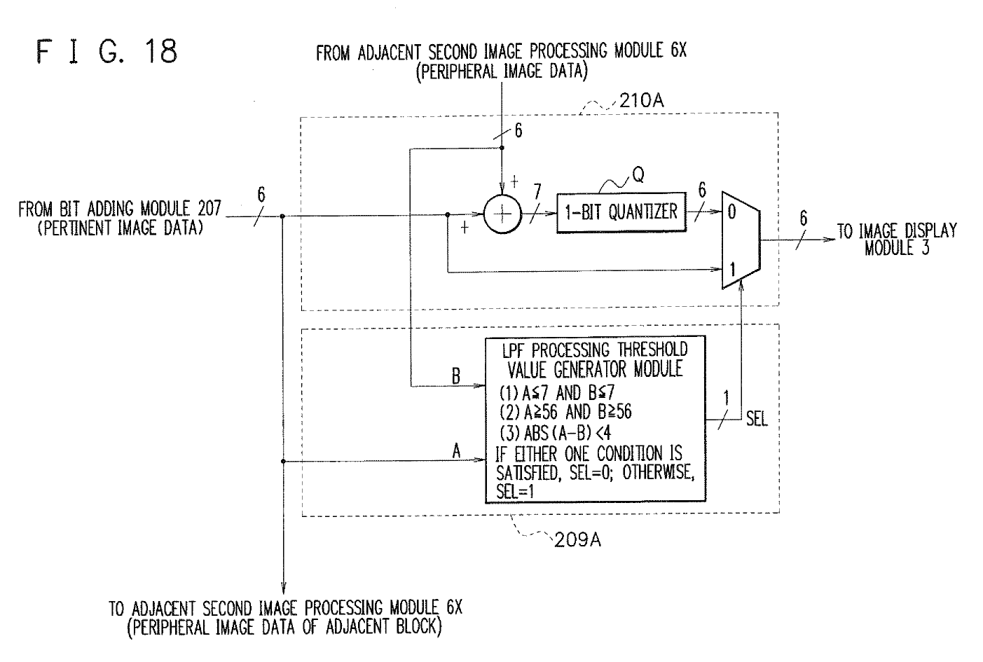

FIG. 19 is a diagram showing structure of an apparatus to carry out an image processing method according to the sixth exemplary embodiment to which the present invention is suitably applied.

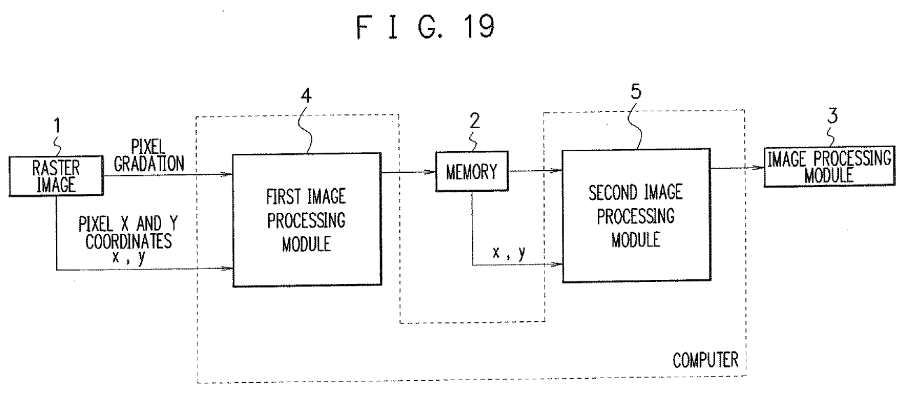

FIG. 20 is a flowchart showing a flow of processing of the image processing method according to the sixth exemplary embodiment.

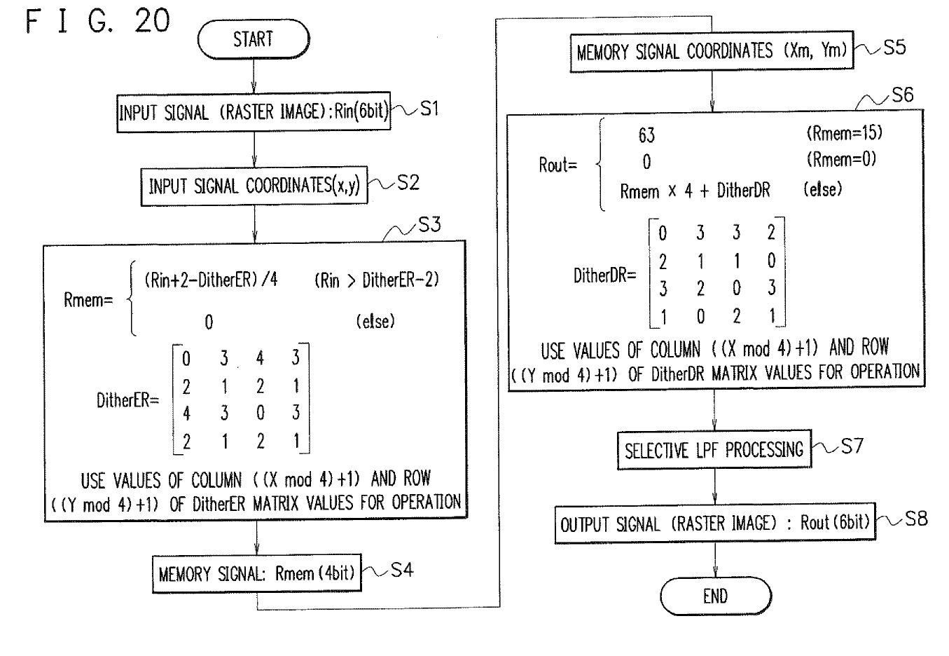

FIG. 21 is a diagram showing a flow of processing of the first image processing in the image processing method according to the sixth exemplary embodiment.

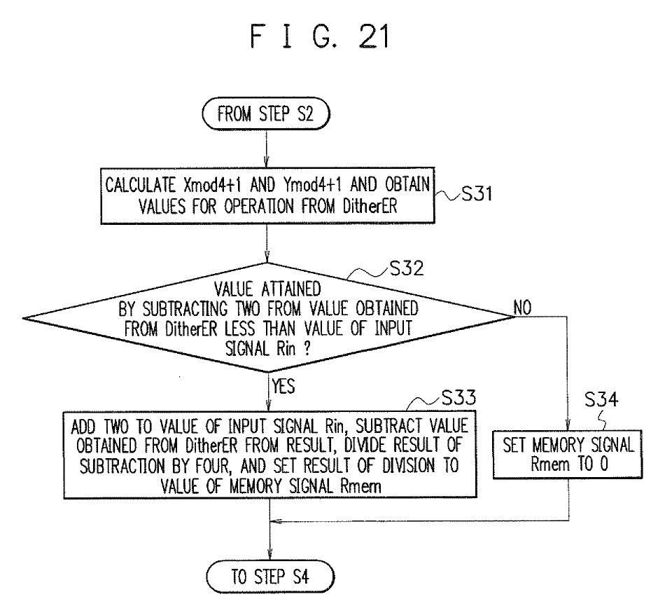

FIG. 22 is a flowchart showing a flow of the bit adding processing in the image processing method according to the sixth exemplary embodiment.

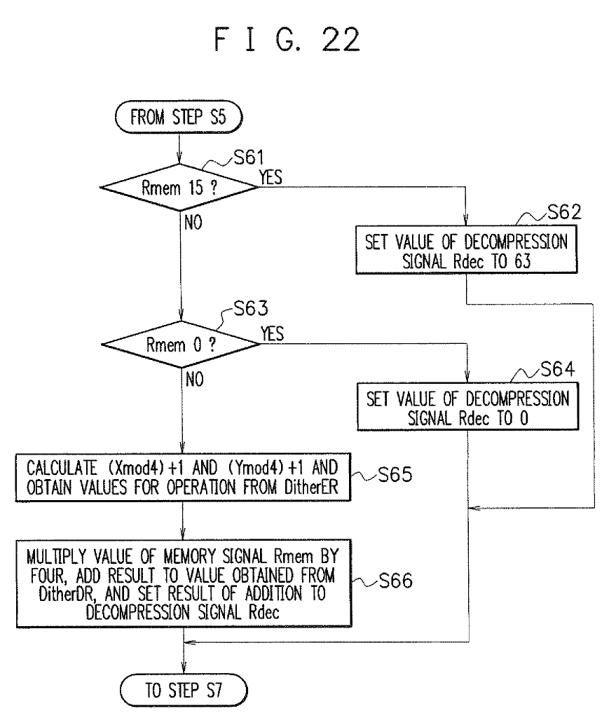

FIG. 23 is a flowchart showing a flow of the selective LPF processing in the image processing method according to the sixth exemplary embodiment.

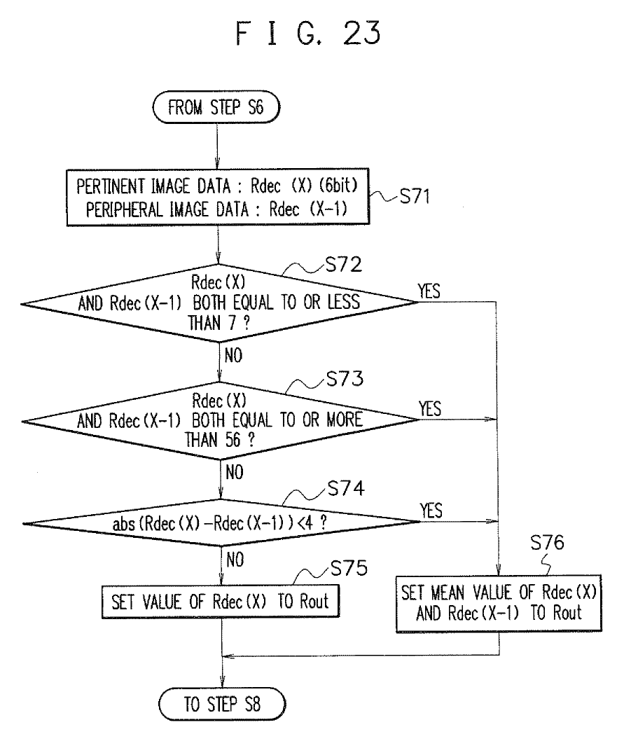

### DESCRIPTION OF REFERENCE NUMERALS

1 Raster image
2 Memory
3 Image display module
4 First image processing module
5, 6A, 6B, 6C, 6D Second image processing module
7 First apparatus
8 Second apparatus
204 Counter
205 Compression threshold value generator module
206 Decompression threshold value generator module
207 Bit adding module
208 Quantizer
209 LPF processing threshold value generator module
210 LPF processing module

1-42. (canceled)

43. An image processing apparatus comprising a first image processing unit which compresses input image data to reduce a data amount of the data and generating compressed data, a memory for storing the compressed data of the image, and a second image processing unit which decompresses the compressed data read from the memory and producing output image data, characterized in that:
the first image processing unit comprises a compression threshold value generator module for generating a two-dimensional dither matrix on the basis of x and y coordinates of the input image data and a bit plane compressing unit which executes multi-value dither processing for the input image data by use of a compression threshold value based on the two-dimensional dither matrix to reduce the number of bit planes for the input image data and obtaining the compressed data; and
the second image processing unit comprises a bit plane decompressing module for executing bit adding processing based on the two-dimensional dither matrix for the compressed data read from the memory and obtaining decompressed data, a smoothing threshold value generator module for obtaining a threshold value from the decompressed data of an arbitrary pixel, and a smoothing processing module which attains a difference between the decompressed data of an arbitrary pixel and the decompressed data of a peripheral pixel thereof, which sets a result of weighted mean processing for the decompressed data of an arbitrary pixel and the decompressed data of the peripheral pixel to the output image data if the difference value is within the threshold value, and which sets the decompressed data of an arbitrary pixel to the output image data if the difference value is more than the threshold value.

44. The image processing apparatus in accordance with claim 43, characterized in that the compression threshold value generator module generates the two-dimensional dither matrix on the basis of a data value of the input image data as well as the x and y coordinates of the input image data.

45. The image processing apparatus in accordance with claim 43, characterized in that the smoothing processing module produces the output image data on the basis of the decompressed data of a plurality of peripheral pixels of the arbitrary pixel.

46. The image processing apparatus in accordance with claim 43, characterized in that the bit plane decompressing module sets a value of the decompressed data to a value corresponding to a maximum gradation value if a value of the compressed image data is an available maximum value and sets the value of the decompressed data to a value corresponding to a minimum gradation value if the value of the compressed image data is an available minimum value.

47. The image processing apparatus in accordance with claim 43, characterized in that the bit plane decompressing module executes the bit adding processing on the basis of the two-dimensional dither matrix by use of a decompression threshold value different from the compression threshold value.

48. The image processing apparatus in accordance with claim 43, characterized in that the smoothing processing module sets, if both of a value of the decompressed data of the arbitrary pixel and a value of the decompressed data of the peripheral pixel are equal to or less than a first predetermined value, the result of the weighted mean processing as the output data regardless of the value of the differential value.

49. The image processing apparatus in accordance with claim 43, characterized in that the smoothing processing module sets, if both of a value of the decompressed data of the arbitrary pixel and a value of the decompressed data of the peripheral pixel are equal to or more than a second predetermined value, the result of the weighted mean processing as the output data regardless of the value of the differential value.

50. The image processing apparatus in accordance with claim 43, characterized in that the smoothing threshold value generator module obtains a threshold value on the basis of the decompressed data of the arbitrary pixel and the compressed data of the pixel.

51. An image processing apparatus comprising first image processing means for compressing input image data to reduce a data amount of the data and generating compressed data, a memory for storing the compressed data of the image, and second image processing means for decompressing the compressed data read from the memory and producing output image data, characterized in that:
the first image processing means comprises a compression threshold value generator module for generating a two-dimensional dither matrix on the basis of x and y coordinates of the input image data and bit plane compressing means for executing multi-value dither processing for the input image data by use of a compression threshold value based on the two-dimensional dither matrix to reduce the number of bit planes for the input image data and obtaining the compressed data; and
the second image processing means comprises a bit plane decompressing module for executing bit adding processing based on the two-dimensional dither matrix for the compressed data read from the memory and obtaining decompressed data, a smoothing threshold value generator module for obtaining a threshold value from the decompressed data of an arbitrary pixel, and a smoothing processing module which attains a difference between the decompressed data of an arbitrary pixel and the decompressed data of a peripheral pixel thereof, which sets a result of weighted mean processing for the decompressed data of an arbitrary pixel and the decompressed data of the peripheral pixel to the output image data if the difference value is within the threshold value, and which sets the decompressed data of an arbitrary pixel to the output image data if the difference value is more than the threshold value.

52. An image transmitting apparatus comprising a first apparatus comprising a first image processing unit which compresses input image data to reduce a data amount of the data and generating compressed data and a unit which transmits the compressed data and a second apparatus comprising a unit which receives the compressed data transmitted from the first apparatus and a second image processing unit which decompresses the compressed data and producing output image data, characterized in that:
the first image processing unit comprises a compression threshold value generator module for generating a two-dimensional dither matrix on the basis of x and y coordinates of the input image data and a bit plane compressing unit which executes multi-value dither processing for the input image data by use of a compression threshold value based on the two-dimensional dither matrix to reduce the number of bit planes for the input image data and obtaining the compressed data; and
the second image processing unit comprises a bit plane decompressing module for executing bit adding processing based on the two-dimensional dither matrix for the compressed data received as above and obtaining decompressed data, a smoothing threshold value generator module for obtaining a threshold value from the decompressed data of an arbitrary pixel, and a smoothing processing module which attains a difference between the decompressed data of an arbitrary pixel and the decompressed data of a peripheral pixel thereof, which sets a result of weighted mean processing for the decompressed data of an arbitrary pixel and the decompressed data of the peripheral pixel to the output image data if the difference value is within the threshold value, and which sets the decompressed data of an arbitrary pixel to the output image data if the difference value is more than the threshold value.

53. The image transmitting apparatus in accordance with claim 52, characterized in that the compression threshold value generator module generates the two-dimensional dither matrix on the basis of a data value of the input image data as well as the x and y coordinates of the input image data.

54. The image transmitting apparatus in accordance with claim 52, characterized in that the smoothing processing module produces the output image data on the basis of the decompressed data of a plurality of peripheral pixels of the arbitrary pixel.

55. An image transmitting apparatus in accordance with claim 52, characterized in that the bit plane decompressing module sets a value of the decompressed data to a value corresponding to a maximum gradation value if a value of the compressed image data is an available maximum value and sets the value of the decompressed data to a value corresponding to a minimum gradation value if the value of the compressed image data is an available minimum value.

56. The image transmitting apparatus in accordance with claim 52, characterized in that the bit plane decompressing module executes the bit adding processing on the basis of the two-dimensional dither matrix by use of a decompression threshold value different from the compression threshold value.

57. The image transmitting apparatus in accordance with claim 52, characterized in that the smoothing processing module sets, if both of a value of the decompressed data of the arbitrary pixel and a value of the decompressed data of the peripheral pixel are equal to or less than a first predetermined value, the result of the weighted mean processing as the output data regardless of the value of the differential value.

58. The image transmitting apparatus in accordance with claim 52, characterized in that the smoothing processing module sets, if both of a value of the decompressed data of the arbitrary pixel and a value of the decompressed data of the peripheral pixel are equal to or more than a second predetermined value, the result of the weighted mean processing as the output data regardless of the value of the differential value.

59. The image transmitting apparatus in accordance with claim 52, characterized in that the smoothing threshold value generator module obtains a threshold value on the basis of the decompressed data of the arbitrary pixel and the compressed data of the pixel.

60. An image transmitting apparatus comprising a first apparatus comprising first image processing means for compressing input image data to reduce a data amount of the data and generating compressed data and means for transmitting the compressed data and a second apparatus comprising means for receiving the compressed data transmitted from the first apparatus and second image processing means for decompressing the compressed data and producing output image data, characterized in that:
the first image processing means comprises a compression threshold value generator module for generating a two-dimensional dither matrix on the basis of x and y coordinates of the input image data and bit plane compressing means for executing multi-value dither processing for the input image data by use of a compression threshold value based on the two-dimensional dither matrix to reduce the number of bit planes for the input image data and obtaining the compressed data; and
the second image processing means comprises a bit plane decompressing module for executing bit adding processing based on the two-dimensional dither matrix for the compressed data received as above and obtaining decompressed data, a smoothing threshold value generator module for obtaining a threshold value from the decompressed data of an arbitrary pixel, and a smoothing processing module which attains a difference between the decompressed data of an arbitrary pixel and the decompressed data of a peripheral pixel thereof, which sets a result of weighted mean processing for the decompressed data of an arbitrary pixel and the decompressed data of the peripheral pixel to the output image data if the difference value is within the threshold value, and which sets the decompressed data of an arbitrary pixel to the output image data if the difference value is more than the threshold value.

61. An image display device comprising a first image processing unit which compresses input image data to reduce a data amount of the data and generating compressed data, a memory for storing the compressed data, a second image processing unit which decompresses the compressed data read from the memory and producing output image data, and an image display unit which displays an image of the output image data, characterized in that:
the first image processing unit comprises a compression threshold value generator module for generating a two-dimensional dither matrix on the basis of x and y coordinates of the input image data and a bit plane compressing unit which executes multi-value dither processing for the input image data by use of a compression threshold value based on the two-dimensional dither matrix to reduce the number of bit planes for the input image data and obtaining the compressed data; and
the second image processing unit comprises a bit plane decompressing module for executing bit adding processing based on the two-dimensional dither matrix for the compressed data read from the memory and obtaining decompressed data, a smoothing threshold value generator module for obtaining a threshold value from the decompressed data of an arbitrary pixel, and a smoothing processing module which attains a difference between the decompressed data of an arbitrary pixel and the decompressed data of a peripheral pixel thereof, which sets a result of weighted mean processing for the decompressed data of an arbitrary pixel and the decompressed data of the peripheral pixel to the output image data if the difference value is within the threshold value, and which sets the decompressed data of an arbitrary pixel to the output image data if the difference value is more than the threshold value.

62. The image display device in accordance with claim 61, characterized in that the compression threshold value generator module generates the two-dimensional dither matrix on the basis of a data value of the input image data as well as the x and y coordinates of the input image data.

63. The image display device in accordance with claim 61, characterized in that the smoothing processing module produces the output image data on the basis of the decompressed data of a plurality of peripheral pixels of the arbitrary pixel.

64. The image display device in accordance with claim 61, characterized in that the bit plane decompressing module sets a value of the decompressed data to a value corresponding to a maximum gradation value if a value of the compressed image data is an available maximum value and sets the value of the decompressed data to a value corresponding to a minimum gradation value if the value of the compressed image data is an available minimum value.

65. The image display device in accordance with claim 61, characterized in that the bit plane decompressing module executes the bit adding processing on the basis of the two-dimensional dither matrix by use of a decompression threshold value different from the compression threshold value.

66. The image display device in accordance with claim 61, characterized in that the smoothing processing module sets, if both of a value of the decompressed data of the arbitrary pixel and a value of the decompressed data of the peripheral pixel are equal to or less than a first predetermined value, the result of the weighted mean processing as the output data regardless of the value of the differential value.

67. The image display device in accordance with claim 61, characterized in that the smoothing processing module sets, if both of a value of the decompressed data of the arbitrary pixel and a value of the decompressed data of the peripheral pixel are equal to or more than a second predetermined value, the result of the weighted mean processing as the output data regardless of the value of the differential value.

68. The image display device in accordance with claim 61, characterized in that the smoothing threshold value generator module obtains a threshold value on the basis of the decompressed data of the arbitrary pixel and the compressed data of the pixel.

69. An image display device comprising first image processing means for compressing input image data to reduce a data amount of the data and generating compressed data, a memory for storing the compressed data, second image processing means for decompressing the compressed data read from the memory and producing output image data, and image display means for displaying an image of the output image data, characterized in that:
the first image processing means comprises a compression threshold value generator module for generating a two-dimensional dither matrix on the basis of x and y coordinates of the input image data and bit plane compressing means for executing multi-value dither processing for the input image data by use of a compression threshold value based on the two-dimensional dither matrix to reduce the number of bit planes for the input image data and obtaining the compressed data; and
the second image processing means comprises a bit plane decompressing module for executing bit adding processing based on the two-dimensional dither matrix for the compressed data read from the memory and obtaining decompressed data, a smoothing threshold value generator module for obtaining a threshold value from the decompressed data of an arbitrary pixel, and a smoothing processing module which attains a difference between the decompressed data of an arbitrary pixel and the decompressed data of a peripheral pixel thereof, which sets a result of weighted mean processing for the decompressed data of an arbitrary pixel and the decompressed data of the peripheral pixel to the output image data if the difference value is within the threshold value, and which sets the decompressed data of an arbitrary pixel to the output image data if the difference value is more than the threshold value.

70. An image processing method comprising a first image processing step of compressing input image data to reduce a data amount of the data and generating compressed data, a step of storing the compressed data in a memory, and a second image processing step of decompressing the compressed data read from the memory and producing output image data, characterized in that:
the first image processing step executes compression threshold value generating processing for generating a two-dimensional dither matrix on the basis of x and y coordinates of the input image data and bit plane compressing processing of executing multi-value dither processing for the input image data by use of a compression threshold value based on the two-dimensional dither matrix to reduce the number of bit planes for the input image data and obtaining the compressed data; and
the second image processing step executes bit plane decompressing processing of executing bit adding processing based on the two-dimensional dither matrix for the compressed data read from the memory and obtaining decompressed data, smoothing threshold value generating processing for obtaining a threshold value from the decompressed data of an arbitrary pixel, and smoothing processing which attains a difference between the decompressed data of an arbitrary pixel and the decompressed data of a peripheral pixel thereof, which sets a result of weighted mean processing for the decompressed data of an arbitrary pixel and the decompressed data of the peripheral pixel to the output image data if the difference value is within the threshold value, and which sets the decompressed data of an arbitrary pixel to the output image data if the difference value is more than the threshold value.

71. The image processing method in accordance with claim 70, characterized in that the compression threshold value generating processing generates the two-dimensional dither matrix on the basis of a data value of the input image data as well as the x and y coordinates of the input image data.

72. The image processing method in accordance with claim 70, characterized in that the smoothing processing produces the output image data on the basis of the decompressed data of a plurality of peripheral pixels of the arbitrary pixel.

73. The image processing method in accordance with claim 70, characterized in that the bit plane decompressing processing sets a value of the decompressed data to a value corresponding to a maximum gradation value if a value of the compressed image data is an available maximum value and sets the value of the decompressed data to a value corresponding to a minimum gradation value if the value of the compressed image data is an available minimum value.

74. The image processing method in accordance with claim 70, characterized in that the bit plane decompressing processing executes the bit adding processing on the basis of the two-dimensional dither matrix by use of a decompression threshold value different from the compression threshold value.

75. The image processing method in accordance with claim 70, characterized in that the smoothing processing sets, if both of a value of the decompressed data of the arbitrary pixel and a value of the decompressed data of the peripheral pixel are equal to or less than a first predetermined value, the result of the weighted mean processing as the output data regardless of the value of the differential value.

76. The image processing method in accordance with claim 70, characterized in that the smoothing processing sets, if both of a value of the decompressed data of the arbitrary pixel and a value of the decompressed data of the peripheral pixel are equal to or more than a second predetermined value, the result of the weighted mean processing as the output data regardless of the value of the differential value.

77. The image processing method in accordance with claim 70, characterized in that the smoothing threshold value generating processing obtains a threshold value on the basis of the decompressed data of the arbitrary pixel and the compressed data of the pixel.

78. An image transmitting method comprising a first image processing step of compressing input image data to reduce a data amount of the data and generating compressed data, a step of transmitting the compressed data, and a second image processing step of decompressing the compressed data and producing output image data, characterized in that:
the first image processing step executes compression threshold value generating processing of generating a two-dimensional dither matrix on the basis of x and y coordinates of the input image data and bit plane compressing processing of executing multi-value dither processing for the input image data by use of a compression threshold value based on the two-dimensional dither matrix to reduce the number of bit planes for the input image data and obtaining the compressed data; and
the second image processing step executes bit plane decompressing processing of executing bit adding processing based on the two-dimensional dither matrix for the compressed data transmitted as above and obtaining decompressed data, smoothing threshold value generating processing of obtaining a threshold value from the decompressed data of an arbitrary pixel, and smoothing processing which attains a difference between the decompressed data of an arbitrary pixel and the decompressed data of a peripheral pixel thereof, which sets a result of weighted mean processing for the decompressed data of an arbitrary pixel and the decompressed data of the peripheral pixel to the output image data if the difference value is within the threshold value, and which sets the decompressed data of an arbitrary pixel to the output image data if the difference value is more than the threshold value.

79. The image transmitting method in accordance with claim 78, characterized in that the compression threshold value generating processing generates the two-dimensional dither matrix on the basis of a data value of the input image data as well as the x and y coordinates of the input image data.

80. The image transmitting method in accordance with claim 78, characterized in that the smoothing processing produces the output image data on the basis of the decompressed data of a plurality of peripheral pixels of the arbitrary pixel.

81. The image transmitting method in accordance with claim 78, characterized in that the bit plane decompressing processing sets a value of the decompressed data to a value corresponding to a maximum gradation value if a value of the compressed image data is an available maximum value and sets the value of the decompressed data to a value corresponding to a minimum gradation value if the value of the compressed image data is an available minimum value.

82. The image transmitting method in accordance with claim 78, characterized in that the bit plane decompressing processing executes the bit adding processing on the basis of the two-dimensional dither matrix by use of a decompression threshold value different from the compression threshold value.

83. The image transmitting method in accordance with claim 78, characterized in that the smoothing processing sets, if both of a value of the decompressed data of the arbitrary pixel and a value of the decompressed data of the peripheral pixel are equal to or less than a first predetermined value, the result of the weighted mean processing as the output data regardless of the value of the differential value.

84. The image transmitting method in accordance with claim 78, characterized in that the smoothing processing sets, if both of a value of the decompressed data of the arbitrary pixel and a value of the decompressed data of the peripheral pixel are equal to or more than a second predetermined value, the result of the weighted mean processing as the output data regardless of the value of the differential value.

85. The image transmitting method in accordance with claim 78, characterized in that the smoothing threshold value generating processing obtains a threshold value on the basis of the decompressed data of the arbitrary pixel and the compressed data of the pixel.

86. A computer-readable medium storing an image processing program characterized by making a computer execute an image processing method in accordance with claim 70.

87. A computer-readable medium storing an image transmitting program characterized by making a computer execute an image transmitting method in accordance with claim 78.
